(19) United States
(12) Patent Application Publication
(10) Pub. No.: US 2018/0174121 A1
(43) Pub. Date: Jun. 21, 2018

(54) DATA TRANSFER DURING ELECTRONIC TRANSACTIONS

(71) Applicant: MAXWELL FOREST PTY LTD, Surry Hills, New South Wales (AU)

(72) Inventors: Matthew Charles Denton, Surry Hills, New South Wales (AU); Anthony Mark Schofield, Surry Hills, New South Wales (AU)

(21) Appl. No.: 15/737,207

(22) PCT Filed: Jun. 17, 2016
(86) PCT No.: PCT/AU2016/050514

§ 371 Date: Dec. 15, 2017

Related U.S. Application Data
(60) Provisional application No. 62/181,661, filed on Jun. 18, 2015.

(51) Int. Cl. G06Q 20/12; G06Q 20/10; G06Q 20/40; G06Q 20/32; G06Q 30/06; G06Q 40/02

(52) U.S. Cl. CPC G06Q 20/12; G06Q 20/10; G06Q 40/02; G06Q 20/3276; G06Q 30/0613; G06Q 20/40

(57) ABSTRACT

A computer-implemented method is provided. The method includes displaying, on an end user device (14), a page associated with an e-commerce transaction and receiving, at the end user device, an initiation instruction to commence a checkout process associated with the e-commerce transaction. A funds request message including at least a client identifier associated with the end user is transmitted to a bank server (20), in response to which a funds availability message to determine whether an end user has sufficient funds to conclude the e-commerce transaction is received from the bank server. A total purchase price associated with the e-commerce transaction and an indication to show whether the user has sufficient funds available to conclude the e-commerce transaction are then displayed at the end user device, An authorisation from the end user to proceed with the e-commerce transaction is received, in response to which information to conclude the e-commerce transaction is sent to a third party server associated with the e-commerce transaction.

### FIELD

The present disclosure relates to systems and methods for managing data transfer during electronic transactions. In one application, the present disclosure relates to a system and method for managing data transfer within an online shopping and/or e-commerce environment. The present disclosure may also extend to data transfer between a financial institution and an end user device during e-commerce transactions.

### BACKGROUND

The ever-increasing number of online offerings by merchants and service providers, as well as the need of consumers to simplify their personal and business affairs through the use of various electronic modes have resulted in an almost constant need for individuals to enter personal details into electronic, online systems.

For example, to use an online shopping service a user typically needs to register with a merchant website by providing identification, billing and delivery information. This information may be stored for later use by the merchant, e.g., for subsequent online e-commerce transactions. At least some of this information, e.g., billing, payment (such as credit card details) and delivery information, may need to be provided each time a transaction is performed. Even in circumstances where information is stored by the merchant, website or mobile application, the user will need to go through a registration or login process, e.g., by entering a registration details and/or a username and password when the mobile application or site is accessed or a purchase is made. This can be quite burdensome and time-consuming for the user providing the information. It may also hamper the conclusion of transactions, e.g., in cases where a user is unable to remember login or password details. Moreover, with the popularity of portable computing devices, many of which do not have full sized keyboards, this task requires some dexterity and patience to perform. The result is that many users of online shopping services abandon their purchases due to difficulty with this process, leading to lost sales by the merchant.

There are also many other contexts in which a user is required to provide data in a structured fashion for transmission via a communications channel to another party. To give but one example, many software applications running on a computing device may require data to be entered in a structured manner for transmission to another device, e.g., to buy goods or services, register user interest in some event or activity, make a booking, enter login credentials, fill in forms, etc. These situations also give rise to the same problems as the online shopping example given above, in that a user needs to enter data in a structured fashion into the application, which may again result in abandonment before the completion and submission of forms.

Closely related to this need for convenience when providing personal information, is a need for security, especially as the personal information provided by a user, whether during e-commerce transactions or the submission of forms, typically includes sensitive information, in the form of billing and transactional information such as credit card details, social security information or the like.

In terms of online shopping or other e-commerce transactions where a payment is to occur, such electronic transactions may not be completed in instances where a user has insufficient funds available. A user typically has no means to directly communicate with a financial institution such as a bank in order to address the lack of funds.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY

According to an aspect there is provided a computer-implemented method comprising:

displaying, on an end user device, a page associated with an e-commerce transactions;

receiving, at the end user device, an initiation instruction to commence a checkout process associated with the e-commerce transaction;

transmitting, to a bank server, a funds request message including at least a client identifier associated with an end user;

receiving from the bank server a funds availability message to determine whether the end user has sufficient funds to conclude the e-commerce transaction;

displaying, at the end user device, a total purchase price associated with the e-commerce transaction and an indication to show whether the end user has sufficient funds available to conclude the e-commerce transaction; and

receiving an authorisation from the end user to proceed with the e-commerce transaction.

The funds availability message may include an indication of an amount of funds available in an account of the end user. The funds availability message may also include a total credit limit associated with the account of the end user. The funds availability message may also include a statement date associated with the amount of funds available.
The funds request message may include a total purchase price to conclude the e-commerce transaction. The bank server typically processes the funds request message to generate the funds availability message.
In some instances, the funds availability message received from the bank server may include an offer to extend credit (e.g., raise a credit limit) of an account of the end user, the method further comprising:

displaying, on the end user device, the offer to extend credit, together with the total purchase price to conclude the e-commerce transaction and the funds available in the account of the user.

The offer to extend credit may be presented to the end user as a soft button, a URL link to a credit request form, as an email or as a telephone number to call.
The offer to extend credit may be an offer to permanently or temporarily extend credit on the end user account.
The bank server may include an offer to raise a credit limit on the account of the end user if it is determined that the user does not have sufficient funds available to conclude the e-commerce transaction. Alternatively, the bank server may include an offer to raise a credit limit on the account of the end user if it is determined that the funds available in the user account will fall below a predetermined minimum value after the e-commerce transaction has completed.
The method may further comprise, in response to displaying the offer to raise the user's credit limit, receiving, from the end user device an input accepting the offer to raise the user's credit limit, transmitting an acceptance message to the bank server and displaying an updated available funds amount at the user device which amount includes the raised credit limit.
The method may further comprise determining that the initiation instruction to commence a checkout process has been received from a secondary user device registered with the end user device.
The client identifier associated with the end user may be received as part of the initiation instruction.
The page may be a web page associated with a website or may alternatively be a screen or interface associated with a mobile application.
According to yet a further aspect there is provided a system comprising:

a processor; and

a computer-readable storage medium having stored therein instructions which, when executed by the processor, cause the processor to perform operations comprising the method steps defined above.

According to a further aspect there is provided a computer-implemented method comprising:

receiving, at a bank server and from an end user device executing an e-commerce transaction, a funds request message to obtain an indication of available funds in an account associated with an end user, the funds request message including at least a client identifier associated with the end user;

by using the client identifier, performing a lookup of the account associated with the client identifier to determine an amount of funds available in the account; and

generating a funds availability message for transmission to the end user device, the funds availability message including information on the amount of funds available in the account of the user, which information is to be displayed on the end user device.

The funds request message may include a total purchase price to conclude the e-commerce transaction on the end user device.
The method may further comprise, if the bank server determines the account associated with the user identifier not to have sufficient funds to conclude the e-commerce transaction, including in the funds availability message information on an offer to extend credit on the account of the end user.
Alternatively, the bank server may include an offer to extend credit on the account of the end user if it is determined that the funds available in the user account will fall below a predetermined minimum value after the e-commerce transaction has concluded.
The method may further comprise receiving, from the end user device an acceptance message accepting the offer to extend credit.

As used herein, except where the context requires otherwise, the term “comprise” and variations of the term, such as “comprising”, “comprises” and “comprised”, are not intended to exclude further additives, components, integers or steps.

Further aspects of the present disclosure and further embodiments of the aspects described in the preceding paragraphs will become apparent from the following description, given by way of example and with reference to the accompanying drawings.

### BRIEF DESCRIPTION OF THE DRAWINGS

FIG. 1 shows a schematic overview of a system in which the current disclosure finds application comprising an end user device, a secondary user device, an e-commerce merchant server, an application processing system, and a bank server in accordance with one example embodiment;

FIG. 2 is a block diagram of a typical electronic communication device for use as the end user device in accordance with an example embodiment;

FIG. 3 is a block diagram of an electronic device for use as the secondary user device in the form of a small form factor device in accordance with an example embodiment;

FIG. 4 is a block diagram of functional components of a typical computer system for use as an e-commerce merchant server, application processing system, and bank server of FIG. 1 in accordance with an example embodiment;

FIG. 5 shows various screenshots displayed in an example embodiment on the end user device of FIG. 1 during a process of establishing connection between the end user device and the secondary user device of FIG. 1;

FIG. 6 shows various screenshots displayed in an example embodiment on the end user device of FIG. 1 during a process of activating the secondary user device of FIG. 1;

FIG. 7 shows an example flow diagram of the processes for establishing communication and activating the secondary user device, the processes being shown at and between the end user device, secondary user device and bank server of FIG. 1, in accordance with one example embodiment;

FIGS. 8A and 8B show an example flow diagram of the processes for generating a website and automated submission (checkout), the processes being shown at and between the end user device, the secondary user device and the merchant server, bank server and the application processing server of FIG. 1, in accordance with one and more example embodiments;

FIGS. 9 and 10 show various screenshots displayed on the end user device of FIG. 1 during an automated submission (auto-checkout) process, in accordance with one example embodiment;

FIG. 11 shows various screenshots displayed on the end user device of FIG. 1 during an automated submission (auto-checkout) process, in accordance with another example embodiment;

FIG. 12 shows an example flow diagram to illustrate processes of communication between the bank server and the end user device of FIG. 1, the processes being shown at and between the end user device, the secondary user device and the bank server of FIG. 1 in accordance with another example embodiment of a checkout process; and

FIG. 13 shows a data structure detailing data/information necessary for the process of auto-checkout in accordance with one or more example embodiments.

### DETAILED DESCRIPTION OF THE EMBODIMENTS

Overview

Embodiments described herein generally relate to an online shopping environment. It will however be appreciated that embodiments could extend to an online electronic submission process, e.g., a process for the submission and/or registration of personal data on government or other websites, which may, but need not be associated with the delivery of goods and/or services. These embodiments allow for an automated (in some instances, semi-automated) submission of information process with limited end user input, in order to conclude an e-commerce transaction or to submit all relevant information forming part of a the more general submission of data process.

It will be appreciated that these information submission processes may be executed through the use of multiple web pages of a website, or that it may execute through different screens or user interfaces of a mobile application. Generally, these web pages of websites or screens/user interfaces of mobile applications may generally be referred to as “pages”. User data input fields may accordingly extend across these pages, i.e. web pages or screens/user interfaces. Although the embodiments described below relates to web pages, it will be appreciated that described features could also find application in mobile applications.

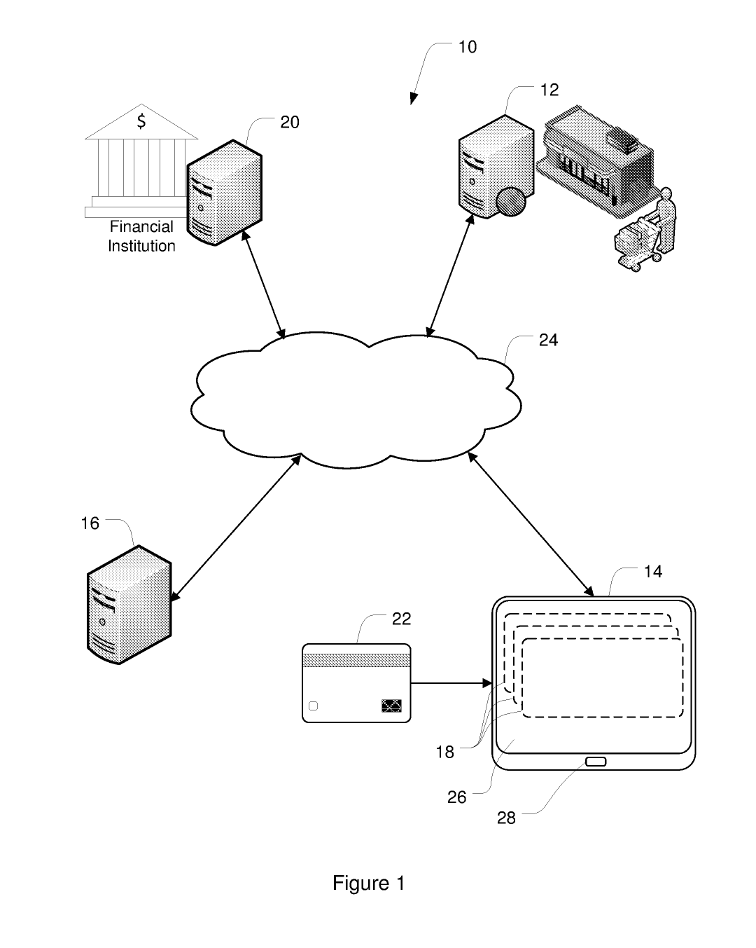

Turning to the particular embodiment of FIG. 1, an online shopping environment 10 is shown where various types of information are to be provided to an electronic commerce (e-commerce) merchant (third party) server 12, with limited end user input, in order to conclude an e-commerce transaction between the end user and the e-commerce merchant. The e-commerce merchant may, for example, provide goods and/or services for sale through an online store making use of a checkout process, which online store is presented as an e-commerce website to the end user on an end user electronic communication device 14. The online store may also, in other embodiments, be presented through a mobile software application (“app”) on the end user electronic communication device 14. In one embodiment, the electronic communication device 14 of the end user is a portable electronic device. As will be apparent from the description below, this e-commerce checkout process is managed as an auto-submission process.

In order for the end user to make a purchase of goods or to enrol for services, personal user information is to be submitted to the e-commerce server 12 through the e-commerce website. This personal information generally includes user data such as identification and personal information of the end user (e.g., login information, user identifying details, etc.), billing information (relating to an account or method of payment for the user such as credit card details) and delivery (shipping) information.

Rather than for the end user to fill in various fields on one or more check-out web pages presented to the end user as part of a check-out (i.e. information submission) process of the e-commerce website, the present embodiments enable the automatic filling (populating) of various, and, depending on the information available, all, data input fields on the check-out pages of the e-commerce website, with information, in one embodiment, being provided from one or more sources. The present embodiments therefore enable the conclusion of the e-commerce transaction with little or no input from the end user, while, and as will be apparent from the description below, maintaining security of end user data. This process is enabled by information being available on the user data input fields forming part of the various web pages of the information submission (check-out) process.

It will be appreciated that in certain circumstances all user personal information may not be available, and that there may be a need to request additional input from the user. This may typically be done by presenting to the end user an additional data input form prior to commencing with the submission process. Users may also be given options to choose from, should a plurality of options for filling a data field be available (such as more than one delivery or billing address). Also, certain data input fields may not allow automatic population, e.g., in cases where a CAPTCHA is to be entered, the input data field is a non-automated manual field in that the information needs to be entered directly by the user. In these circumstances, the user will be presented with the data input fields of the web page already filled, except for the non-automated fields. There may also be a need to request an end user to effect transitioning between subsequent web pages of the submission process, e.g., through the selection of a soft button.

To enable the automatic filling of the various data input fields, an application processing system 16 is to first process a website of an e-commerce merchant (or mobile application) thereby to identify and/or store the various data input fields and associated information needed in order to fill in the data input fields during an information submission process. As will be described in more detail below, once the relevant web pages of an e-commerce website have been processed, the application processing system 16, in one embodiment, generates and/or stores instructions (communication modules), e.g., in the form of javascript modules, which are communicated to an auto-submission application 18 installed on the end user device 14. These instructions identify user data input fields that form part of the information submission process associated with the particular website (e.g., the various web pages of the checkout process). The identified user data input fields accordingly extend across multiple web pages or windows which together form part of the information submission process.

The auto-submission application 18 installed on the end user device 14 has web-browser functionality and it is through this built-in web browser that the e-commerce website of the e-commerce merchant 12 is rendered. During rendering, the auto-submission application 18, in one example embodiment, is to insert the one or more communication modules, e.g., in the form of the javascript modules, received from the application processing system 16 into the e-commerce markup language document of the web page to be viewed, e.g., the html document. These javascript modules provide information to the end user device 14 insofar as the data input fields to be filled. This information is then also used to populate the various user data input fields once the submission process is launched.

In other embodiments, the application processing system 16 may generate or and/or store a discovery file which is to contain relevant information to enable the auto-submission of information, e.g., the data fields to be filled and associated information.

On receipt of an instruction from an end user to commence the automated checkout process, the auto-submission application 18 executed on the end user device 14 is configured to manage the checkout process on behalf of the end user. In one embodiment the auto-submission application 18, which is informed by the application processing system 16, communicates with one or more devices, data stores and/or systems, e.g., a financial institution such as a bank server 20, the e-commerce merchant server 12, a data store (e.g., memory) of the user device 14 and optionally, a secondary user device 22, in order to obtain information relevant to the data input fields. In one embodiment, the secondary user device 22 may be used to also provide the user's initialisation instruction to the auto-submission application 18. Other types of devices or other types of instructions may, of course, also be used to generate an initialisation instruction.

The auto-submission application 18 on the end user device 14 fills the various data fields of the e-commerce merchant website and once a final, albeit optional, confirmation instruction has been received from an end user, the e-commerce transaction is concluded. As mentioned, in one embodiment the submission process typically comprises multiple web pages and a number of user input data fields may be present on each of these web pages. Depending on the particular embodiment, the user may be requested to provide confirmation (transitioning) instructions after the automatic filling of each separate web page (or window), or in some cases, instructions may only be required after particular web pages forming part of the submission process. For example, confirmation may be required only after the automatic filling of billing or delivery data input fields.

The end user device 14 communicates with the various systems 12, 16 and 20 via a network 24. The network 24 may include one or more networks (e.g., local area network, wireless local area network, cellular network, metropolitan area network, wide area network, satellite network, Internet, intranet, radio access network, public switched network. The various components and processes mentioned at a high level above, will now be described in more detail.

After receipt of the initialisation instruction, the auto-submission application 18 may, in some embodiments, be configured to obtain information directly from the bank server 20 in order to determine whether the end user has sufficient funds to purchase an item (or enrol for a service) and therefore conclude the transaction. If the end user does not have sufficient funds, the auto-submission application 18 may, but need not, block further processing of the transaction. In other words, although the auto-submission application may obtain information relevant to the conclusion of the transaction, it need not interfere with the flow of information to the merchant and the conclusion of the transaction.

As will be described in more detail below, the bank server 20 may provide the auto-submission application 18 with an end user's balance of funds or a mere indication that sufficient funds are available. In addition, in some embodiments, the auto-submission application 18 may also be provided with a loyalty point balance of the particular end user. This information may be displayed to the end user as part of the checkout process.

In the event that the end user does not have sufficient funds to conclude the transaction, the auto-submission application 18 may facilitate communication between the bank server 20 and the end user thereby to enable the bank server 20 to offer, and the end user to accept, a temporary or permanent increase in credit limit. Or alternatively, the end user may submit a credit advance request to the bank server 20, which may in turn accept the request and increase the credit limit of the end user. It will be appreciated that the credit advance request may take any form, e.g., it may be a request for a loan, a credit advance or an upgrade in, or benefits of, a credit card.

Embodiments described herein further relate to an online shopping environment 10 where specific user personal information is obtained from a financial institution presented by the bank server 20.

General System/Architecture Description (Hardware)

End user device (tablet/computer)

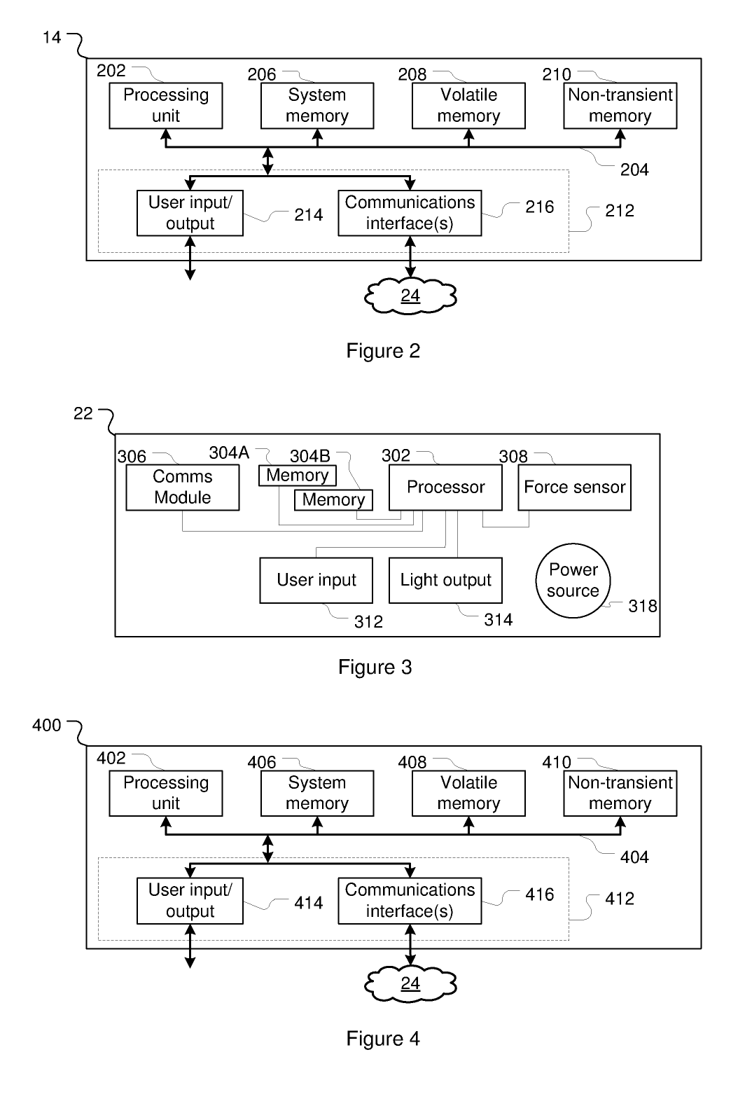

FIG. 2 provides a block diagram of a typical end user device 14. The end user device 14 is configured to communicate and to connect to the network 24 via any suitable wired or wireless network (or combination of them) such that it can exchange data with other devices and/or systems.

Turning to FIG. 2, the end user device 14 has a processing unit 202, which may comprise a single computer-processing device (e.g., a central processing unit, graphics processing unit, or other computational device), or may comprise a plurality of computer processing devices. In some instances processing is performed solely by the processing unit 202, however, in other instances processing may also, or alternatively, be performed by remote processing devices accessible and useable (either in a shared or dedicated manner) by the end user device 14.

Through a communications bus 204 the processing unit 202 is in data communication with one or more machine-readable storage (memory) devices that store instructions and/or data for controlling operation of the end user device 14. In this instance, the end user device 14 comprises a system memory 206 (e.g., a BIOS), volatile memory 208 (e.g., random access memory such as one or more DRAM modules), and non-volatile/non-transient memory 210 (e.g., one or more hard disk or solid state drives).

The end user device 14 also comprises one or more interfaces, indicated generally by 212, via which the end user device 14 interfaces with various components, other devices and/or networks. Generally speaking, other components/devices may be physically integrated with the end user device 14, or may be physically separate. Where such devices are physically separate from the end user device 14, connection between the device and the end user device 14 may be via wired or wireless hardware and communication protocols, and may be direct or indirect (e.g. networked) connections.

Wired connection with other devices/networks may be by any appropriate standard or proprietary hardware and connectivity protocols. For example, the end user device 14 may be configured for wired connection with other devices/communications networks by one or more of: USB; FireWire; eSATA; Thunderbolt; Ethernet; Parallel; Serial; HDMI; DVI; VGA; AudioPort. Other wired connections are, of course, possible.

Wireless connection with other devices/networks may similarly be by any appropriate standard or proprietary hardware and communications protocols. For example, the end user device 14 may be configured for wireless connection with other devices/communications networks using one or more of: infrared; Bluetooth (e.g., Bluetooth 4.0/4.1, also known as Bluetooth low energy); Wi-Fi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are, of course, possible.

Generally speaking, the devices or systems to which the end user device 14 connects—whether by wired or wireless means—allow data to be input into/received by the end user device 14 for processing by the processing unit 202, and data to be output by the end user device 14. Example devices are described below. However, it will be appreciated that not all portable electronic devices will comprise all mentioned devices, and that additional and alternative devices to those mentioned may well be used.

For example, the end user device 14 may comprise or connect to one or more input devices by which information/data is input into (and received by) the end user device 14. Such input devices may comprise physical buttons, alphanumeric input devices (e.g., keyboards), pointing devices (e.g., mice, track-pads and the like), touchscreens, touchscreen displays, microphones, accelerometers, proximity sensors, GPS devices and the like. The end user device 14 may also comprise or connect to one or more output devices controlled by the end user device 14 to output information. Such output devices may comprise devices such as indicators (e.g., LED, LCD or other lights), displays (e.g., LCD displays, LED displays, plasma displays, touch screen displays), audio output devices such as speakers, vibration modules, and other output devices. The end user device 14 may also comprise or connect to devices which may act as both input and output devices, for example memory devices (e.g., hard drives, solid state drives, disk drives, compact flash cards, SD cards and the like) which the end user device 14 can read data from and/or write data to, and touch-screen displays which can both display (output) data and receive touch signals (input).

The end user device 14 may also connect to communications networks (e.g., the Internet, a local area network, a wide area network, a personal hotspot, etc.), such as the network 24, to communicate data to and receive data from networked devices, which may be other computer processing systems.

In one particular embodiment the end user device 14 is a portable electronic device with either a phone form factor or a tablet form factor, such as a mobile phone (or smart phone) or a tablet computer. However, it will be appreciated that the end user device 14 may be any other suitable computer processing system such as, by way of non-limiting example, a laptop computer, a netbook computer, a smart phone, a phablet, a Personal Digital Assistant (PDA) or a cellular telephone. It will also be appreciated that FIG. 2 does not illustrate all functional or physical components of a portable electronic device. For example, no power supply or power supply interface has been depicted, however the end user device 14 will carry a power supply (e.g., a battery). It will further be appreciated that the particular type of end user device will determine the appropriate hardware and architecture, and alternative end user devices may have additional, alternative, or fewer components than those depicted, combine two or more components, and/or have a different configuration or arrangement of components.

For the present example embodiment, we assume that the end user device 14 is a tablet computer, such as an iPad by Apple Inc., of Cupertino, Calif. or a Galaxy Tab by Samsung Electronics Co. Ltd., of Suwon, South Korea, and that the end user device 14 communicates, as already mentioned, with the application processing system 16, the bank server 20 and the e-commerce merchant server system 12 via the network 24, as shown by FIG. 1. In the description below, the terms “end user device” and “tablet computer” 14 will be used interchangeably.

The tablet computer 14 may have (in a physically integrated manner): a touchscreen display 26 (providing both input means and display output means); an audio output device (e.g., a speaker, not shown); an audio input device (e.g., a microphone, not shown); one or more physical inputs 28 (e.g., physical buttons); a location monitoring module (e.g., a position sensor such as a GPS module, not shown); and a wireless communications module for direct communication with other devices (e.g., a Bluetooth communications module such as a Bluetooth low energy (BLE) module, not shown). A tablet computer as a portable electronic device will, of course, include additional components as described above (processing unit, memory, telecommunications network interface(s) etc.).

Operation of the tablet computer 14 is also caused by one or more computer program modules which configure the tablet computer 14 to receive, process, and output data. One such computer program module will be an operating system such as (by way of non-limiting example) Apple iOS or Android.

The tablet computer 14 comprises additional computer program modules executed to cause the electronic device to perform the processes/operations described below. Where software modules are used, instructions and data are stored in non-transient memory such as 210, loaded into volatile memory 208, and executed by the processing unit 202.

As has been mentioned, an application is downloaded and executed on the end user device 14 to enable the rendering of an e-commerce (merchant) website and to provide automated checkout of a shopping cart on the e-commerce website. This auto-submission application 18, which also functions as a browser application, may be downloadable by an end user onto the tablet computer 14 from a suitable application distribution platform such as an application store/market place, e.g., Apple's App Store (for iOS), Google Play (for Android) or other enterprise stores. However, it will also be appreciated that the application may be pre-loaded on the device 14, or that the application may be available directly from a financial institution through a server, such as the bank server 20.

In order to perform the function of auto-filling, and relevant to the description below, is that the auto-submission application 18 is to obtain information relevant to an e-commerce transaction (or more generally, the submission process), including user personal information, from one or more devices and/or systems, such as the tablet computer 14, as stored by the auto-submission application, the secondary user device 22, the application processing server 16, the bank server 20 and the e-commerce merchant server 12.

Secondary User Device (Financial Card Device)

In an embodiment, the secondary user device 22 is a small form factor device in the form of a card that can store data and communicate with another device. One such device has been described in U.S. Ser. No. 62/063320, filed on 13 Oct. 2014 and entitled “Proximity monitoring devices and methods”, which application is incorporated by reference herein in its entirety. The secondary user device 22 typically communicates with an associated device, such as the end user device 14 of FIGS. 1 and 2, i.e. a tablet computer, via a communication channel, that may be a limited-range wireless connection, e.g., a Bluetooth connection (e.g., Bluetooth low energy (BLE) connection). However, in other embodiments, the secondary user device 22 may be a mobile phone, a tablet computer, a personal digital assistant (PDA), or a token/fob, in which case other suitable means or channels of communication may be used to transmit instructions and/or data e.g., an initialisation instruction and/or relevant checkout information, to the auto-submission application 18 on the tablet computer 14, or to other devices and/or systems.

The secondary user device 22 generally comprises a processor 302, memory 304 for storing instructions executable by the processor 302 and data, and a wireless communication module 306 for enabling wireless communications with (i.e. sending messages to and receiving messages from) other devices, as mentioned above. In one particular embodiment the processor 302, memory 304 (which comprises both non-transient memory 304A such as flash memory and volatile memory 304B such as RAM), and communication module 306 are provided in an integrated microcontroller unit (MCU) such as the CC2541 or CC2540 manufactured by Texas Instruments. The communication module in this case is a Bluetooth wireless communications module compliant with Bluetooth version 4.0/4.1 (also referred to as Bluetooth Low Energy (BTLE)). In other embodiments, the communication module 306 may be configured to operate via other limited-range wireless communication channel technologies, such as ZigBee (IEEE 802.15), wireless USB, WiFi, near field communications, or other personal area network communication channels.

In certain embodiments, the secondary user device 22 also comprises a force sensor 308. As used herein, the term “force sensor” is used to generally describe devices/components that either sense forces (e.g., impact, pressure, compression, twisting/bending and the like) or the result of forces (e.g., acceleration) and output force signals in response thereto. In one particular embodiment the force sensor is an accelerometer which outputs force signals in response to the detection of acceleration. By way of example, the force sensor may be an accelerometer such as the ADXL362 manufactured by Analog Devices. The force sensor 308 may also, or alternatively, comprise a piezoelectric sensor.

In certain embodiments the secondary user device 22 further comprises a user input 312 operable by a user to interact with the device 22. The user input 312 may be a simple push-button input which, on activation by a user, sends a signal to the processor 302.

In certain embodiments the secondary user device 22 may also comprise a light output 314. In this case light output 314 is controlled by the processor 302 in order to output visual signals to a user of the device 22. By way of example, light output 314 may be a light emitting diode (LED), such as a 16-219A/S2C-AP1Q2/3T LED manufactured by Everlight.

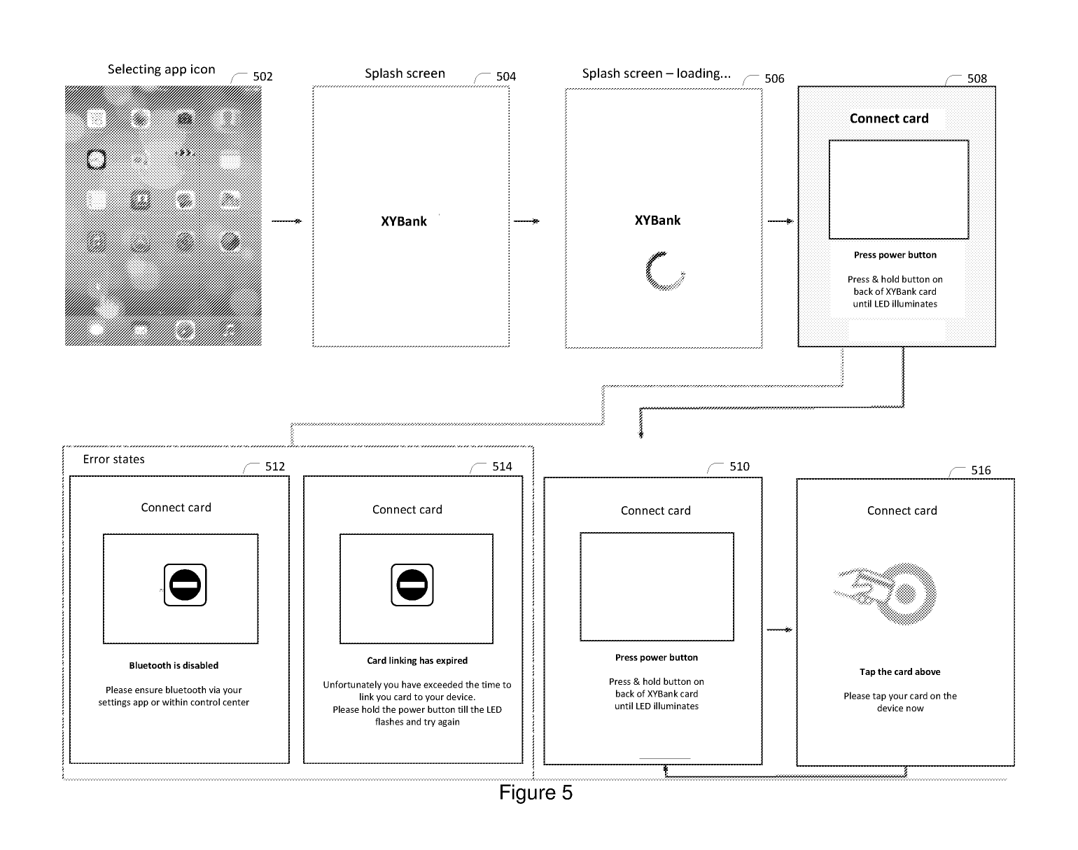

The secondary user device 22 also comprises a power source 318. The power source 318 is connected to and powers those components the device 300 that require power (with connections not indicated in FIG. 3 for clarity)—for example, the MCU (i.e. the processor 302, memory 304, and the communications module 306), the force sensor 308 (in the event an accelerometer is used and power is necessary), and, where included, the light output 314. The voltage supplied by the power source 318 may exceed the voltage required by the MCU. In this case a DC-DC converter is used in order to step down the voltage of the power source 318 (in some cases the DC-DC convertor may be provided as part of the MCU chipset). In one embodiment power source 318 is a battery, such as a LiMn battery (for example manufactured by FDK). In some embodiments the power source 318 may comprise a rechargeable battery, either as the sole power source or in conjunction with a non-rechargeable battery. In this case the secondary user device 22 is also provided with contact points (not depicted) for connecting the secondary user device 22 to a charger to charge the rechargeable battery. In alternative embodiments, the device 22 may be configured to allow for induction charging of the power source 318.

In an embodiment where the secondary user device 22 is a small form factor device, each of its components has a size that allows the components to be embedded in a small form factor device (e.g., a credit card type form factor device, or an ISO 7810 ID-1 compliant device). Alternative components to those specifically mentioned are, of course, possible. E.g., the secondary user device 22 may be thicker than an ISO compliant credit card as specified above.

As discussed in more detail below, the secondary user device 22 is configured for operation by one or more computer program modules. A computer program module may be a software module comprising computer readable instructions (and potentially data) stored in non-transient memory such as 304A. In order for the relevant functionality to be performed, a software module is typically loaded into transient memory such as 304B and executed by the processor 302. Computer program modules may alternatively be implemented in hardware, firmware, or in a combination of software, hardware and/or firmware.

Software and/or firmware instructions/commands and data may be transmitted to/received by the secondary user device 22 via a data signal in a transmission channel enabled (for example) by the communications module 306.

In embodiments described herein, the secondary user device 22 is a payment card device—e.g., a bank card, Visa card, MasterCard, American Express card, Union Pay card or the like. In this case the payment card device 22 is thus also provided with components to enable the device 22 to be used as a payment card—e.g., a magnetic stripe with relevant encoded data, an EMV chip (EMV contact, contactless with antenna, or dual mode contact/contactless with antenna), or a combination thereof.

The payment card device may accordingly be associated with a user account at a financial institution or the like, with the payment card device then being issued by such financial institution.

The components and features of the secondary user device 22 could, of course, be provided in a larger form-factor device, if desired. Alternatively, the device 22 may have other form factors or other sized form-factors including, but not limited to, a key fob, money clip, key, lanyard, watch, pen, coin, clip, tag and buckle form factors.

In addition to storing, in some embodiments, a portion of an end user's data, e.g., data necessary to complete a checkout process during an e-commerce transaction (i.e. a submission process), the secondary user device 22, in the form of the payment card device, may also be used as part of the check-out process by initiating checkout and providing inherent authentication functionality. E.g., and in order to initiate a checkout process while an end user is making purchases on an e-commerce website, the end user may perform a submission (checkout) initiation action with the device 22 that can be sensed by the end user device 14, in order for the application to commence the checkout process and also to transmit data relevant to the checkout process.

The submission initiation action can be any physical action taken with respect to the secondary user device 22—e.g., sensing that the device 22 is being held in a predetermined fashion, that it has been moved in a predetermined fashion either in an absolute sense or relative to another device. This submission initiation action may be sensed by the device 22 itself (e.g., using an onboard touch sensor, accelerometer, imager or the like) or in other embodiments, by another device (e.g., using a camera, or motion sensor of (or connected to) the device 14. Sensors on both devices may cooperate to sense motion of the device 22. As will be appreciated the sensed motion could be sensed relative to the device's 22 original position and/or orientation or relative to device 16 or relative to the direction of gravity.

In one example embodiment the force sensor 308 of the secondary user device 22 senses the predetermined motion and provides an input to the processor 302 which analyses the sensor output and determines according to heuristic rules what type of gesture has been performed. For example, the gesture could be a tap, or series of taps, swipe, or rotation or twist of the at least one device, or a combination of such actions.

In order to indicate to the end user device 14 that the gesture has been performed, the secondary user device 22 sends data representing the performance of the gesture to the end user device 14. This message can include a type of gesture performed, or simply a status message indicating that some gesture has been sensed. Alternatively, instead of processing the sensor data onboard the secondary user device 22, data representing the output of the force sensor 308 can be transmitted to the end user device 14, which can determine correct performance of the gesture.

The secondary user device 22 may also be used to provide final authorisation to conclude the submission process, or to provide inputs during the submission process, e.g., instructions to transition between subsequent web pages forming part of the submission process. For example, a different type of gesture may be required at a later stage during the automatic checkout process.

The data stored on the secondary user device 22 is described in more detail below, under the section data structures. The initial connection process between the device 22 and the end user device 14, as well as the activation of the card is described in accordance with screen shots and flow charts below.

Although a submission initiation action in terms of the secondary user device 22 is described above, a submission initiation instruction may be received without user interaction with a further device such as the secondary user device 22. For example, in one embodiment, the user may provide an input directly through the web page associated with the submission process. This may occur through the selection of a soft button on the web page to commence the submission process, e.g., selection of a “checkout” button.

Overview of Other Systems/Servers

The application processing system 16 is configured to process websites associated with submission processes, e.g., e-commerce websites, and/or to store information relevant to such submission processes. Processing of websites is typically concluded prior to making available to end users the automatic submission (checkout) process of the present embodiments through the use of the auto-submission application 18 installed on the end user device 14.

The bank server 20, in one example embodiment forming part of a larger financial institution server system (not shown), is configured to be in communication with the auto-submission application 18 on the end user device 14 via the network 24. During communication between the bank server 20 and the auto-submission application 18, data relevant to the e-commerce transaction being performed may be transferred between the auto-submission application 18 (i.e. end user device 14) and the bank server 20. The data transferred between the auto-submission application 18 and the bank server 20 is described in more detail below, under the data structure section, and typically includes transactional information such as a total purchase price, available funds of the relevant account, loyalty points and at least a portion of relevant account payment details. In accordance with one aspect of the disclosure, and as mentioned above, transactional information may extend to an offer and acceptance of credit or an increase in credit limit (which may be temporary or permanent), and/or a request and acceptance of credit or other credit card/account benefits. It will be appreciated that this communication with the bank server 20 and its enablement of e-commerce transactions need not be included in all embodiments. Further details on these processes are provided below.

In the present embodiment, the merchant e-commerce server 12, in one example embodiment forming part of a larger merchant system, is also configured to be in communication with the auto-submission application 18 on the end user device 14 via the network 24. During communication between the merchant e-commerce server 12 and the auto-submission application 18, data relevant to the e-commerce transaction is transferred between the auto-submission application 18 (i.e. end user device 14) and the merchant e-commerce server 12. The data transferred between the auto-submission application 18 and the merchant e-commerce server 12 is described in more detail below, e.g., under the section data structures. Typically this data includes data relevant to rendering an e-commerce website, including product information, shopping cart information, transactional information such as end user login information, personal information, address (including delivery/shipping) information, payment details, total purchase price, and a breakdown thereof, etc.

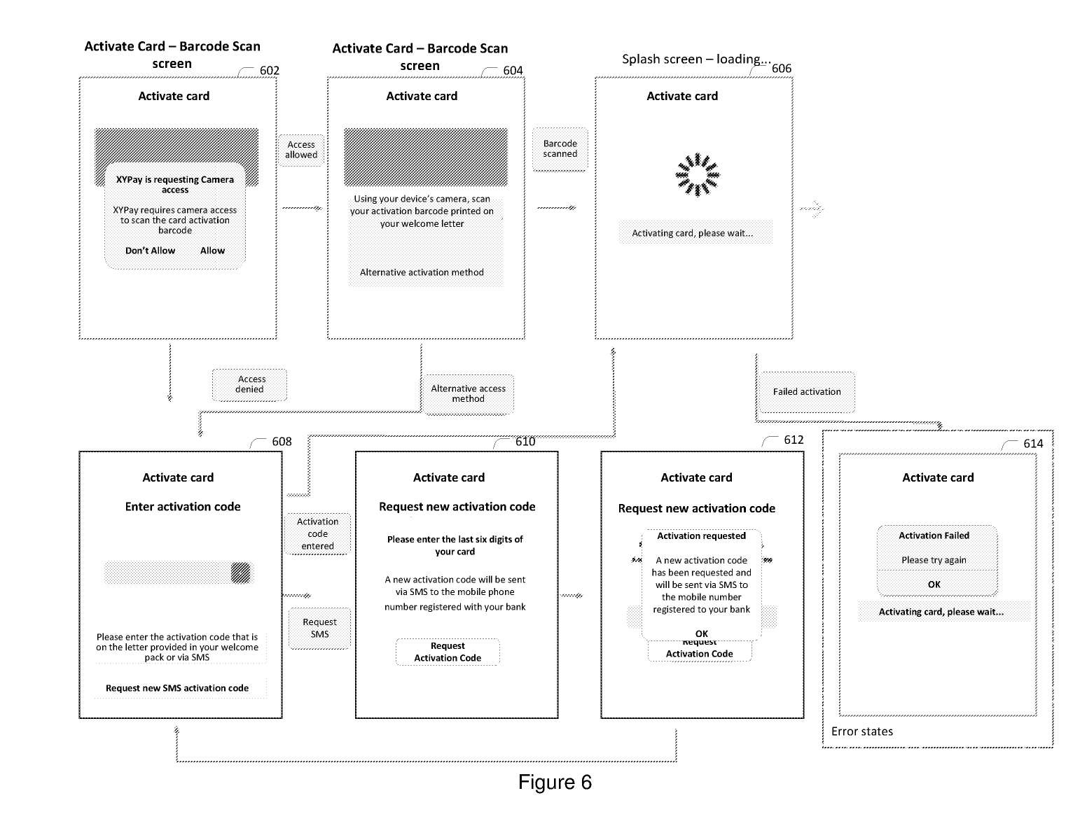

Generally speaking, the systems/servers shown in FIG. 1 (i.e. the application processing system 16, the bank server 20 and/or the e-commerce merchant server 12) may be any computer processing system capable of performing their associated tasks (described in more detail below) and communicating with the auto-submission application program 18 stored on the end user device 14. FIG. 4 provides a block diagram of one type of computer processing system 400 suitable for use/configuration as the application processing system 16, the bank server 20 and/or the e-commerce merchant server 12.

Computer processing system 400 comprises a processing unit 402. The processing unit 402 may comprise a single computer-processing device (e.g. a central processing unit, graphics processing unit, or other computational device), or may comprise a plurality of computer processing devices. In some instances processing is performed solely by processing unit 402, however in other instances processing may also, or alternatively, be performed by remote processing devices accessible and useable (either in a shared or dedicated manner) by the computer processing system 400.

Through a communications bus 404 the processing unit 402 is in data communication with one or more machine-readable storage (memory) devices that store instructions and/or data for controlling operation of the computer processing system 400. In this instance computer processing system 400 comprises a system memory 406 (e.g. a BIOS or flash memory), volatile memory 408 (e.g. random access memory such as one or more DRAM modules), and non-volatile/non-transient memory 410 (e.g. one or more hard disk or solid state drives).

Computer processing system 400 also comprises one or more interfaces, indicated generally by 412, via which the computer processing system 400 interfaces with various components, other devices and/or networks. Other components/devices may be physically integrated with the computer processing system 400, or may be physically separate. Where such devices are physically separate connection with the computer processing system 400 may be via wired or wireless hardware and communication protocols, and may be direct or indirect (e.g., networked) connections.

Wired connection with other devices/networks may be by any standard or proprietary hardware and connectivity protocols. For example, the computer processing system 400 may be configured for wired connection with other devices/communications networks by one or more of: USB; FireWire; eSATA; Thunderbolt; Ethernet; Parallel; Serial; HDMI; DVI; VGA; AudioPort. Other wired connections are possible.

Wireless connection with other devices/networks may similarly be by any standard or proprietary hardware and communications protocols. For example, the computer processing system 400 may be configured for wireless connection with other devices/communications networks using one or more of: infrared; Bluetooth (including early versions of Bluetooth, Bluetooth 4.0/4.1/4.2 (also known as Bluetooth low energy) and future Bluetooth versions); Wi-Fi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are possible.

Generally speaking, the devices to which computer processing system 400 connects—whether by wired or wireless means—allow data to be input into/received by computer processing system 400 for processing by the processing unit 402, and data to be output by computer processing system 400. Example devices are described below, however it will be appreciated that not all computer processing systems will comprise all mentioned devices, and that additional and alternative devices to those mentioned may well be used.

For example, computer processing system 400 may comprise or connect to one or more input devices by which information/data is input into (received by) the computer processing system 400. Such input devices may comprise physical buttons, alphanumeric input devices (e.g., keyboards), pointing devices (e.g., mice, track-pads and the like), touchscreens, touchscreen displays, microphones, accelerometers, proximity sensors, GPS devices and the like. Computer processing system 400 may also comprise or connect to one or more output devices controlled by computer processing system 400 to output information. Such output devices may comprise devices such as indicators (e.g., LED, LCD or other lights), displays (e.g., LCD displays, LED displays, plasma displays, touch screen displays), audio output devices such as speakers, vibration modules, and other output devices. Computer processing system 400 may also comprise or connect to devices capable of being both input and output devices, for example memory devices (hard drives, solid state drives, disk drives, compact flash cards, SD cards and the like) which computer processing system 400 can read data from and/or write data to, and touch-screen displays which can both display (output) data and receive touch signals (input).

Computer processing system 400 may also connect to communications networks (e.g. the Internet, a local area network, a wide area network, a personal hotspot etc.) to communicate data to and receive data from networked devices, which may be other computer processing systems.

The architecture depicted in FIG. 4 may be implemented in a variety of computer processing systems, for example a laptop computer, a netbook computer, a tablet computer, a smart phone, a desktop computer, a server computer. It will also be appreciated that FIG. 4 does not illustrate all functional or physical components of a computer processing system. For example, no power supply or power supply interface has been depicted, however computer processing system 400 will carry a power supply (e.g. a battery) and/or be connectable to a power supply. It will further be appreciated that the particular type of computer processing system will determine the appropriate hardware and architecture, and alternative computer processing systems may have additional, alternative, or fewer components than those depicted, combine two or more components, and/or have a different configuration or arrangement of components.

Operation of the computer processing system 400 is also caused by one or more computer program modules which configure computer processing system 400 to receive, process, and output data. One such computer program module will be an operating system such as (by way of non-limiting example) Apple iOS or Android.

As used herein, the term “module” to refers to computer program instruction and other logic for providing a specified functionality. A module can be implemented in hardware, firmware, and/or software. A module is typically stored on the storage device 408, loaded into the memory 406, and executed by the processor 402.

A module can include one or more processes, and/or be provided by only part of a process. Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

It will be appreciated that the types of computer systems 400 used by the respective entities of FIG. 1 may vary depending upon the embodiment and the processing power used by the entity. For example, the server systems may comprise multiple blade servers working together to provide the functionality described herein.

In use, each of the devices and systems 12, 16, 20 and 22 is able to communicate with the auto-submission application 18 on the end user device 14, and vice versa, in order to cooperate in the storage and transmission of data required for checkout on particular e-commerce websites. Data transmitted from the auto-submission application 18 on the user end device 14, as well as stored on the user end device 14, may be encrypted to ensure that it can only be decrypted by an intended destination device or system, e.g., in the present embodiment the merchant e-commerce server 12 or the bank server 20, or when authorised for use by the auto-submission application 18.

Although other types of devices (such as smart phones and laptop computers) may be used in other embodiments for the end user device 14 and secondary user device 22, in the description below, unless otherwise indicated, the end user device 14 is a tablet computer, while the secondary user device 22 is a small form factor device, and particularly, a financial card device as described above.

In order to employ embodiments herein described, an end user is to download the auto-submission application 18 from an application storefront onto the user's tablet computer 14. In this particular e-commerce transaction embodiment, the end user also needs to enrol for a program through a suitable financial institution such as a bank, which results in the financial institution issuing a financial card device 22 to the end user, which is to be used in conjunction with the auto-submission application 18. The financial card device 22 may of course also be suitable for normal use as a credit or debit card. Typically, at the time of issuance of the financial card device 22, the bank issues a letter welcoming the end user to the program, which letter includes financial card device activation/verification instructions and credentials (described in more detail below).

In embodiments where the secondary user device 22 is not a financial card device 22 but a mobile phone or the like, it may still be necessary for the end user to register with a financial institution such as a bank in order to receive at least activation/verification credentials prior to registering with the auto-submission application 18. It will however be appreciated that the end user may already be a client/customer of the bank, and that registration may merely be for this additional (add-on) service. It will further be appreciated that in embodiments relating to a submission process not forming part of an e-commerce transaction, prior registration with a financial institution may not be a requirement, while in some embodiments, no secondary user device 22 may be used, as mentioned above.

The following enrolment, application (e.g., website or mobile application) backend processing and submission processes are described with reference to the mentioned e-commerce transaction embodiment where a user makes an online purchase through an end user device (a tablet computer) on which the auto-submission application has been downloaded, together with inputs from a secondary user device (as a financial card device). Variations of this embodiment are to find application in other information submission processes, and/or embodiments not employing all mentioned devices or systems, would be apparent to a person skilled in the art.

Enrolment

Establishing Communication with the Secondary User Device

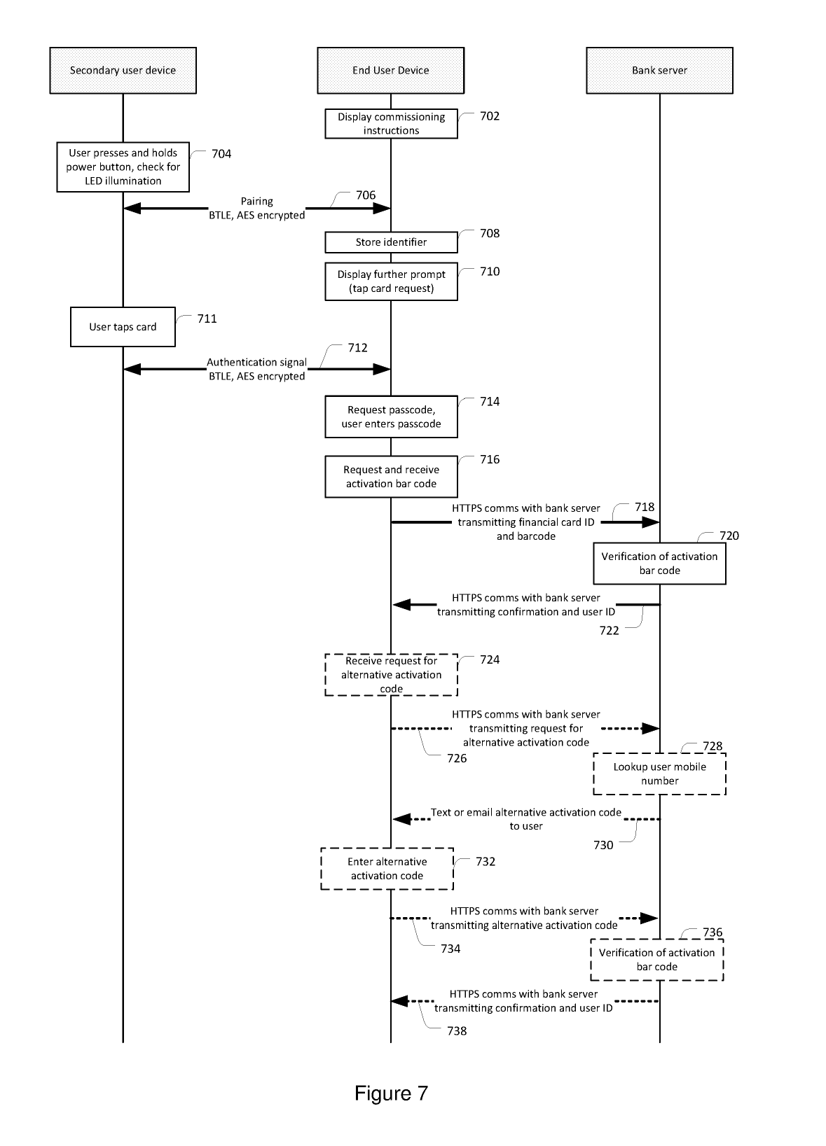

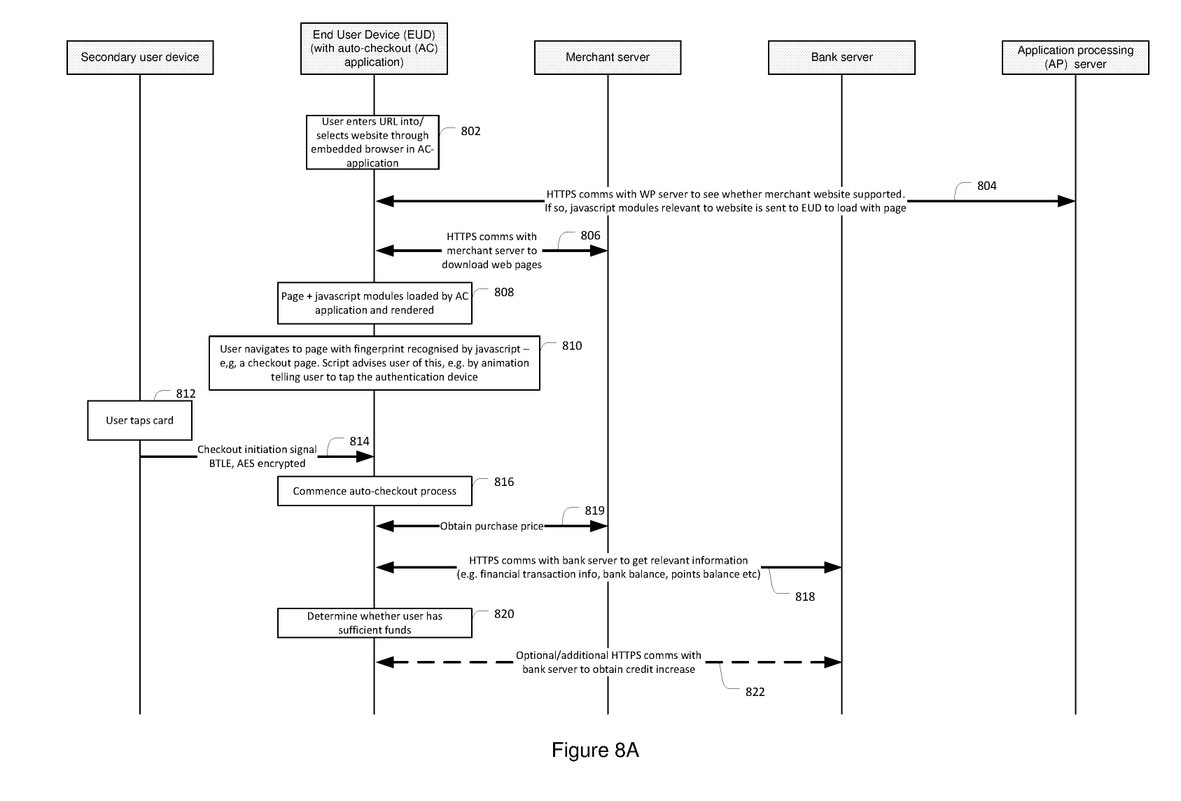

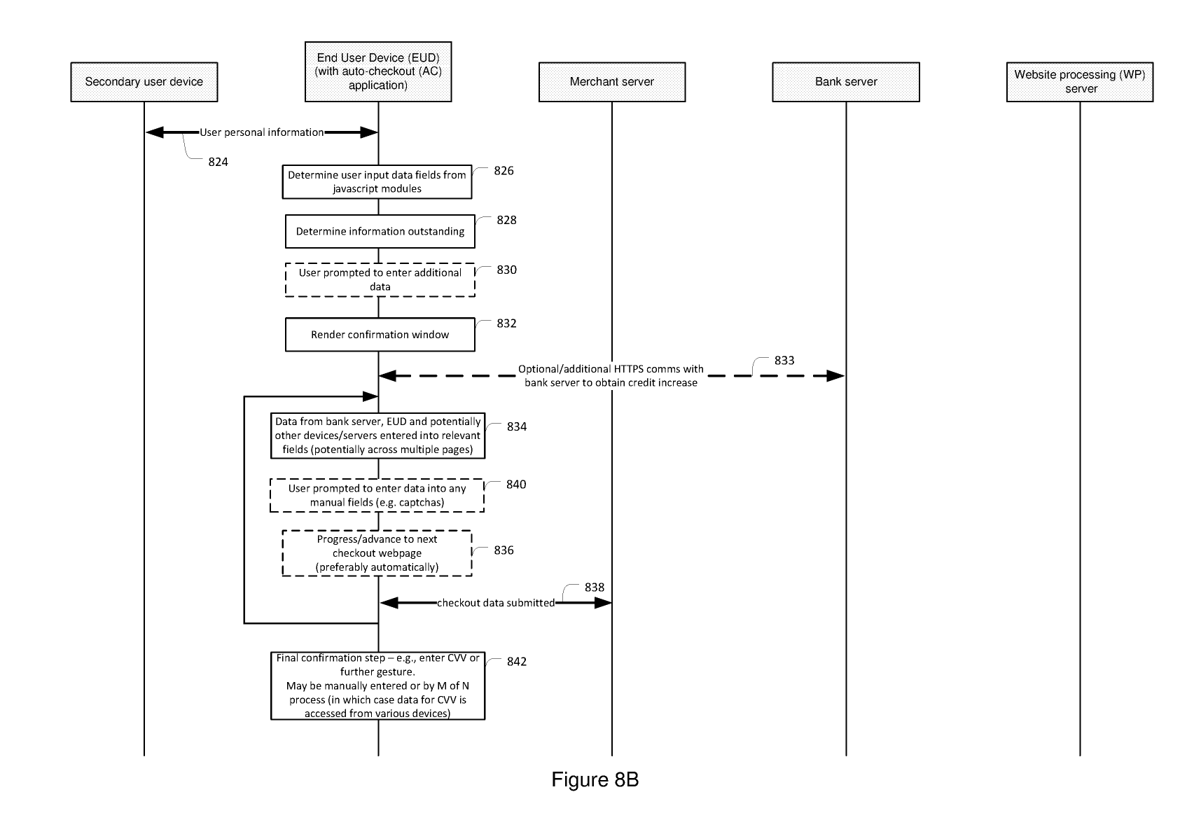

Enrolment, which includes establishing communication between the tablet computer 14 and the secondary user device 22, as well as sharing login credentials and activation of the secondary user device 22, is described with reference to the screenshots of FIGS. 5 and 6 and the flow diagram of FIG. 7.

The tablet computer 14 software, including the auto-submission application 18, and the financial card device 22 software, each includes commissioning modules which are executed in order to establish an initial connection between the tablet computer 14 and the financial card device 22, thereby to enable the transmission of data between the devices. For example, the end user selects an icon on the tablet computer 14 to initiate and use the web-browser functionality of the auto-submission application 18 (see screen 502 of FIG. 5). While the application 18 loads on the tablet computer 14, the user may be provided with splash screens (screens 504 and 506) indicating the loading of the program. The commissioning module of the auto-submission application 18 is configured to display to the user (screen 508 and operation 702 in FIG. 7), on the tablet computer 14, instructions to commission the financial card device 22 when the auto-submission application 18 is executed for the first time on the tablet computer 14.

In one embodiment, the financial card device 22 is initially supplied to the user (i.e. as shipped from the factory) powered off and in an uncommissioned state.

In order to commission the financial card device 22, a user may be prompted by the auto-submission application 18 to activate the financial card device 22 through the user input 312. This may, for example, be by a long press of a button input (operation 704) or similar (the long press reducing the likelihood that the financial card device 22 will be inadvertently activated during transport). On activation the financial card device 22 illuminates its LED (still operation 704, screen 510) and transitions into an advertising state during which it advertises its presence (using the communications module 306) for a predefined period of time (e.g., 65 seconds). During this process of advertising, the financial card device 22 transmits its financial card device identifier which is stored in the end user device's non-transient memory (operations 706 and 708). If no connection is made between the tablet computer 14 and the financial card device 22 in the predefined time period, the financial card device 22 is not commissioned and transitions back to the off state. This avoids power draw during manufacturing and/or transit where the user input can be unintentionally pressed. In the case of a connection not being made, the commissioning module of the auto-submission application 18 may present the user with error messages on the tablet computer 14 screen thereby to enable rectification of a problem (screens 512 and 514). E.g., the user may be prompted to enable Bluetooth (screen 512) and/or to retry the commissioning steps (screen 514).

If a connection is made with the tablet computer 14, the connection is maintained while the tablet computer 14 checks with the user that the financial card device 22 is connected. This may be achieved, for example, by flashing the light output 314 on the financial card device 22 and optionally, asking the user to confirm the flashing light by activation of the user input 312.

If the tablet computer 14 receives confirmation that the financial card device 22 is connected (as confirmed by the user), communication with the financial card device 22 is established. As mentioned, the tablet computer 14 keeps track of the unique financial card device identifier (e.g., the Bluetooth MAC address) for future communications by storing the identifier in its non-transient memory.

If no confirmation is received, the tablet computer 14 disconnects from the financial card device 22.

Alternative processes are, of course, possible. For example, in an embodiment where the secondary user device 22 is a mobile phone, communication may be established through a Bluetooth connection, hotspot connection or similar tethering process.

Once the financial card device 22 and the tablet computer 14 has established communication, the auto-submission application 18 may prompt the user to perform a particular action to transition to the next step (screen 516, operation 710). For example, in the case of the financial card device 22 being a small form factor device, the user may be prompted to execute a gesture, such as a tap of the device 22 above the tablet computer 14.

The financial card device 22 registers this gesture (operation 711), processes it and transmits a suitable gesture command to the auto-submission application 18 for further processing.

Login Credentials

On recognizing the gesture command, the commissioning module of the auto-submission application 18 is configured to create login credentials for the user, e.g., a passcode, which would have to be entered by the user every time the user is to use the auto-submission application 18. The use of such a passcode is to increase security features of the application 18.

The auto-submission application 18 prompts the user to create a passcode (operation 714). Depending on the type of security measures required for the use of the application, a user may be required to enter a simple four digit code, or a more complex alphanumeric passcode. Alternatively, the auto-submission application may record biometric features of the user (e.g., a fingerprint) in order to act as an alternative type of passcode. Once the passcode is entered or recorded, the user is asked to confirm the passcode, with successful confirmation resulting in saving the passcode in the non-transient memory 210 of the tablet computer 14. Every time the user is to run the auto-submission application 18 on the tablet computer 14, the user will need to enter the passcode. The auto-submission application 18 is then to compare the entered passcode with the stored passcode, and only in the event that the passcodes match, will the user be provided with access to the auto-submission application 18.

It will be appreciated that in other example embodiments, alternative to the use of a passcode only, the user may provide other login credentials to establish a user account with the auto-submission application 18. For example, the login credentials may include a username and password, which on registration would allow a user with access to the auto-submission application 18.

These alternative methods of entering login credentials may be especially suitable in circumstances where the auto-submission application 18 is to identify one of multiple users associated with the same device, e.g., such as in the case of a tablet computer being used by different members of a family.

Secondary User Device Activation

The commissioning process also comprises a secondary user device activation step, which may differ in accordance with the type of secondary user device used as part of the system. In the present example embodiment, a device identifier associated with the financial card device 22 may be used, e.g., a unique card identification number, (e.g., a MAC address), barcode, QR code, etc. printed on associated documentation, or provided via a different communication channel, e.g., as a text message or as part of an email. In the present embodiment, where the secondary user device is a financial card device 22, the auto-submission application 18 is to prompt the user to scan an activation barcode associated the financial card device 22 (screens 602 to 606, operation 716). This activation barcode would typically be printed on documentation made available to the end user at the same time as the financial card device 22, e.g., on a welcoming letter. For example, as a small form factor card, an entity (such as a financial institution or the like) would have issued the card to a user, together with a document that sets out the use of the card, and other relevant information. The activation barcode would typically be printed on this documentation.

The user is then to take a photograph of the activation bar code with the tablet computer 14, whereafter the auto-submission application 18 establishes communication with the bank server 20 in order for the activation bar code to be verified against the records of the bank server 20 (operation 718, 720). In one example embodiment, the auto-submission application 18 transmits to the bank server 20 the barcode identifier. The bank server 20 performs a lookup against the received barcode and if the barcode is found valid, a confirmation message is transmitted back to the tablet computer 14 (operation 722). This confirmation message may include a unique customer identifier to be used for further transactions. The unique customer identifier may, e.g., be a customer reference number only suitable for use with transactions through the auto-submission applications, rather than a user account number.

In the event that this type of card activation cannot be completed, e.g., the barcode to be scanned is damaged or the documentation has been lost, the auto-submission application 18 may provide the user with an alternative activation code and/or method (screens 608 to 614, operations 724 to 740). The user may, e.g., be provided with an option to request a one-time password in the form of an activation code (screen 608, operation 724) to be sent via a text message or an email to a user device, e.g., the user's mobile device which may, in one embodiment, be the tablet computer 14. The user is then to enter the alternative activation code into the auto-submission application 18 (screen 610 and 612, operation 732), which is then to transmit this alternative activation code, thereby to activate the financial card device with the bank server 20.

In the examples described above, the activation of the financial card device 22 is closely related to the user's relationship with the bank. For example, in this example embodiment where the secondary user device is a financial card device 22, it is the bank that will issue the financial card device 22 to the user. The financial institution will accordingly save, as part of a user record, the issued financial card device barcode identifier. If the end user requests an alternative activation code (operation 724), the auto-submission application 18 is to communicate with the bank server 20 to request the alternative activation code to be issued to the user (operation 726). That is, the auto-submission application 18 is to transmit the request to the bank server 20, together with additional information to identify the user. The bank server 20 will then perform a lookup (using the additional identification information) to identify the user to which the financial card device 22 had issued (operation 728). On identifying the relevant user record, the bank server 20 will generate or obtain an alternative activation code and transmit it, by suitable channel to the user, e.g., via text message or email (operation 730). Information on the suitable channel, e.g., the user's mobile telephone number or email address, will be accessible to the bank server 20 thereby enabling the bank server 20 to send the alternative activation code to the user.

It will be appreciated that the additional information to identify the user may be personal details of the user, such as a surname and part of the financial card number, the card's MAC address, if available, the mobile telephone number of the user, or the like.

The activation process may be adapted to support either pre-commissioned or uncommissioned (blank/virgin) financial card devices. For example, in the case of pre-commissioned cards, some or all personal information may be stored on the memory of the financial card device when it ships. Alternatively, the financial card device may ship with only the intended user's name printed on the card, while all other information is transferred and stored on the financial card device once the financial card device has been commissioned. For example, the information may be transferred to the financial card device via, e.g., Bluetooth or through direct contacts or any other suitable means, by the commissioning module of the auto-submission application 18 whereafter it is written to the financial card device by the commissioning module of the financial card device software. In one embodiment, the information stored on the financial card device, may, e.g., be the unique customer identifier received from the bank server, which unique customer identifier would be used in all communications between the financial card device 22, the auto-submission application 18 and the bank server 20.

It will be appreciated that the ‘activation’ of the secondary user device 22 may be different in other example embodiments. For example, in the event that the end user device 14 is a tablet computer, and the secondary user device is a smart phone, the primary method of activation of the secondary user device 22 as an integral part of the system may be through receipt of a text message (an SMS code) or email from the bank server that provides an appropriate activation code for entering into the auto-submission application 18, as described above. Alternatively, the activation code may be provided to the user through a dedicated banking application executed on the secondary user device 22, an online banking website, a customer call support centre or the like. Once the activation code is entered through the auto-submissions application 18 and, if applicable, verified by the bank server 20, the particular device is activated and registered with the auto-submission application 18 through the use of the unique customer identifier.

Personal Information Capture

In one embodiment, before an end user is allowed to make use of the auto-submission application 18, the end user is to provide user information to the auto-submission application 18. This information is typically stored by the auto-submission application 18 in the non-transient memory 210 of the tablet computer 14, in an encrypted form. However, and as described in PCT/AU2015/050001 and entitled “Secure storage of data among multiple devices” by the same applicant, which document is hereby incorporated by reference in its entirety, portions of this information may be stored across a number of devices/systems. In one embodiment, information provided by a user may optionally be verified against information stored by other servers or systems, e.g., by the bank server 20, which would have detailed client information stored on the user. For example, the system may be adapted to verify additional addresses including a home address, shipping address, billing address, or the like.

The auto-submission application 18 is to prompt the user, through various user interfaces, to provide user data such as user personal information, e.g., full name(s), last name(s), nickname or preferred name(s), telephone number(s), email address(es), date of birth, social security number (if applicable), as well as address information that may include a postal address, a billing address, and one or more delivery (shipping) addresses.

The user data may also include the user name and password for a number of different services (e.g., for various online e-commerce websites), seating preferences (e.g., for venues, airlines etc.), dietary preferences (e.g., allergies or the like), employment data (e.g., job title, employment date, company, work contact details), club membership details (number, membership date, expiration date), loyalty program enrolment details (program, status, points), and one time key or other system for two factor authentication.

In one example embodiment, user data obtained from the end user does not include transaction card details (e.g., type, holder name, card number, expiration date, card security code/card verification value) for transaction cards (e.g., debit or credit cards), account/client number for one or more store accounts, bank account details. In one example embodiment, this information is obtained from the bank server 20 during the submission process, which is described in more detail below.

Alternatively, in another example embodiment, data obtained from the user may include only a portion or portions or all of the transaction card details or account/client number, which one or more portions may be stored by the bank server, the financial card device 22 or other systems/devices. Portions of this information, if not received from the end user, may also be obtained from the bank server 20 or other devices/systems, as mentioned above.

As mentioned further below, tokens may also be used to obtain information, e.g., from the bank server.

Back-End Processing of Website

In order for the auto-submission application 18 to perform its functions, it is necessary to first process websites or mobile applications, e.g., an ecommerce website on which the auto-submission process is to be performed. As mentioned, this processing allows the application processing system 16 to identify and store the various data input fields and associated information needed in order for the auto-submission application 18 to fill in the data input fields on pages, e.g., an e-commerce website during an auto-submission (check-out) process. This information is typically transmitted by the application processing system 16 to the auto-submission application 18 when a request is received from the auto-submission application 18 on the tablet computer 14.

Once a particular website or mobile application has been processed, an identifier is stored for future use. For example, after an e-commerce website is processed, a website identifier for the website is stored in a database associated with the application processing system 16, together with all relevant information relating to the merchant website.

It will be appreciated that the processing of websites or mobile applications may be a manual, automatic or semi-automatic process. In other words, processing of websites or mobile applications having submission pages or screens (interfaces), e.g., e-commerce websites, may have varying input from an application processing operator.

During this process, each of the relevant pages from which submission of information, i.e. checkout, may occur is to be identified. The aim of the back-end processing is to identify all the data input fields which are to be filled (or populated) during the submission process, these data input fields typically extending across multiple pages (e.g., web pages or screens) that form part of the submission process. The data input fields to be identified typically also include manual (non-automated) data input fields such as CAPTCHA's, as well as the inputs necessary to progress between subsequent web pages of the submission procedure, e.g., suitable submission or transition soft buttons. These soft buttons are typically indicated on the web pages as “Proceed” or “Next”.

The types of data input fields that are identified as forming part of a particular information submission process may relate to personal information of the user (e.g., full name, last name, date of birth, contact details including a telephone (e.g., mobile) number, email address, billing address and delivery address), and, in the case of a checkout process, payment details (e.g., credit card number, type of card, holder name, expiry date, CVV, etc). In some embodiments, it may also be necessary for a user to log in to the particular e-commerce merchant website prior to commencing the checkout process. It may therefore be necessary to also identify username and password data fields.

In one embodiment, the application processing system 16 generates and/or stores instructions that will enable the auto-submission application 18 to perform its functions, based on the identified user data input fields. These instructions effectively provide a suitable mapping, to be used by the auto-submission application 18, to obtain relevant user information and to fill the identified fields during the automatic field filling process. The instructions may be in the form of communication modules, e.g., javascript modules, which are, on request, communicated to the auto-submission application 18. Alternatively, the instructions may be stored as a discovery file, also used by the auto-submission application 18 for automatically filling user data input fields.

Also stored against the website identifier is a status of the website, e.g., whether the website is white-listed (i.e. the website has been processed and is approved/cleared for an auto-submission process), black-listed (i.e. the website is blocked from auto-submission process), or the website has a pending status (i.e. the website is to be processed in the future). Some black-listed websites may be rendered and displayed by the auto-submission application, but auto-submission of data may not be enabled on the website. Alternatively, the auto-submission application may block some black-listed websites, resulting in the application not rendering and displaying the website.

A fingerprint of the website and any other suitable information may also be stored against the website identifier thereby to identify a particular web page as a suitable launching point of the auto-submission application 18.

Auto-Submission Process

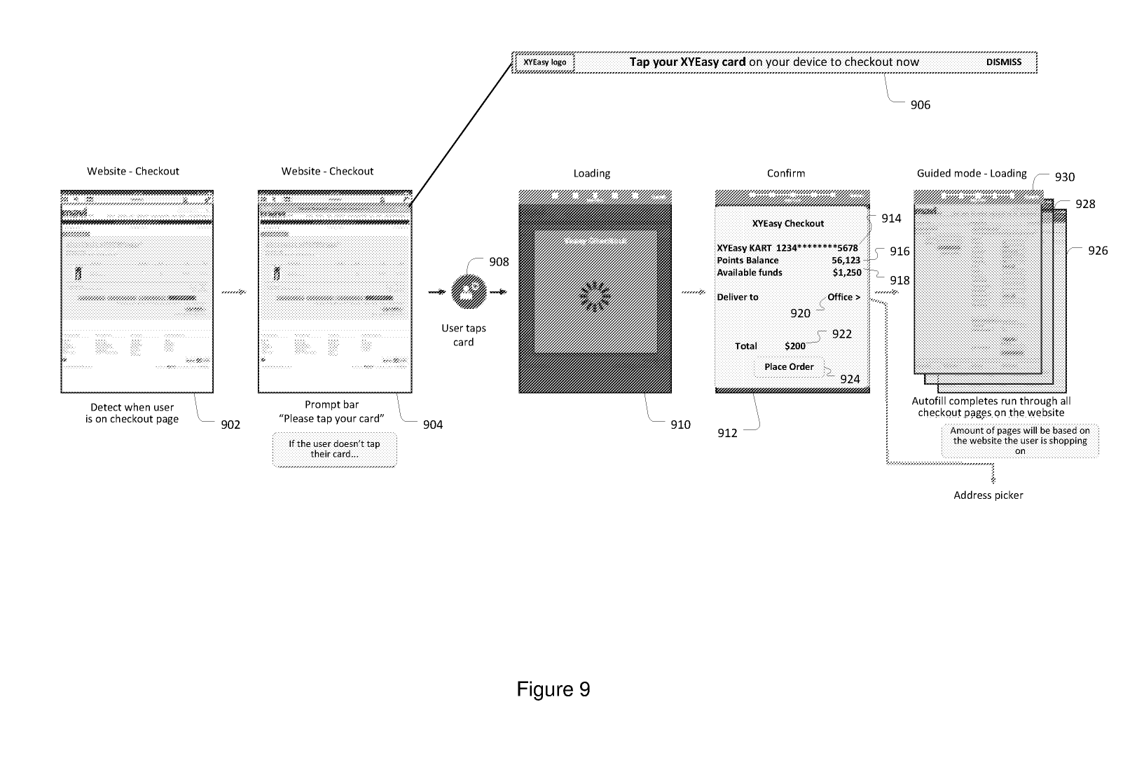

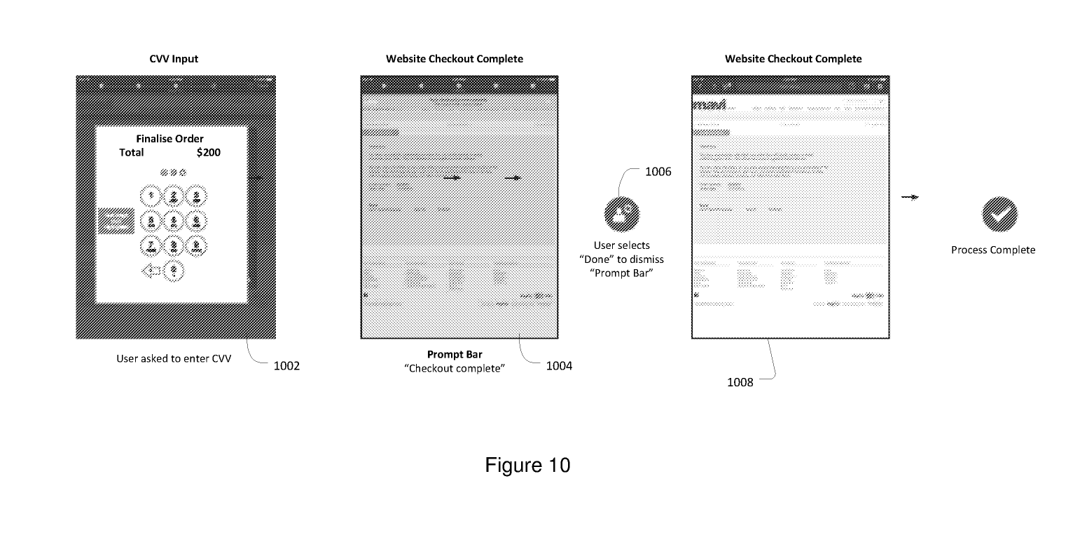

The auto-submission (checkout) process is described below with reference to FIGS. 8A and 8B, as well as screenshots of the auto-submission application 18, as presented on the end user device 14 and as shown by FIGS. 9 to 11.

As already mentioned, the auto-submission application 18 has a web browser module that either runs as a modified web browser (e.g., having a plug-in to perform the methods described herein) or runs as a special purpose application which has a browser functionality and is used to access websites (on which auto-fill checkout may be performed).

In an example embodiment, the auto-submission application 18 is branded as a web browser of the financial institution of the bank server 20. This instils confidence into the minds of end users in that users tend to trust the security systems associated with offerings of their financial institution. It will however be appreciated that in other applications, the auto-submission application may be associated with another third party, e.g., a government organisation which is to obtain information from individuals.

In order for the end user to interact with the auto-submission application 18, the end user selects the auto-submission application 18 on the tablet computer 14, in response to which the end user is prompted to provide login credentials, e.g., the passcode mentioned above. On receipt of the passcode, the auto-submission application 18 compares the passcode against the passcode stored in the memory 210 of the table computer 14 during commissioning, and provides the end user with access to the auto-submission application 18 in the event that it is a match. Alternatively, and after a predetermined amount of failed attempts in entering the passcode, the user is locked out of the auto-submission application 18.

Once the end user has been validated by the passcode, the end user is presented, in one example embodiment, with a store directory comprising multiple icons each of which represents an e-commerce website that has already been processed by the application processing system 16. In some embodiments, the store directory may be personalised by the end user, in which case the end user may add websites that have not yet been processed by the application processing system 16.

As shown by operation 802 in FIG. 8A, the end user accesses a website either by selecting one of these website icons, alternatively by entering a URL in an address/location bar of the web browser or selecting it from a picker. This is deemed, by the web browser module of the auto-submission application 18, to be an instruction to render the web page.

In response to this selection, or the entering of the URL, the web browser module of the auto-submission application 18 is configured to enable the tablet computer 14 on which it is executed to communicate with the application processing system 16. For example, the auto-submission application 18 is to establish a network connection to the application processing system 16 by sending a request to the application processing system 16 to establish communication (operation 804). The application processing system 16 then performs an optional parsing step before conducting a lookup of information stored against the high-level domain of the URL (e.g., the website identifier) that has been sent through by the auto-submission application 18. During this step, a status associated with the website identifier is determined, i.e. whether the website has already been processed and is an approved website (white-listed) or blacklisted.

The application processing system 16 looks the website identifier up in its website database and if the website identifier is present and white-listed, the application processing system 16 responds to the auto-submission application 18 by sending through information (and commands) identifying multiple user data input fields that form part of a submission process associated with the website (operation 804). As already mentioned, this information is provided to the auto-submission application 18 as communication modules in the form of javascript modules associated with the particular e-commerce website. Auto-checkout in accordance with this disclosure will be available for this website.

In one embodiment, the web browser module of the auto-submission application 18 is still to render a website that is blacklisted, but the auto-submission functionality of the application 18 will not be available. Alternatively, the web browser module of the auto-submission application 18 may be configured not to render a blacklisted website at all, e.g., in a case where a website has been compromised by a computer virus or the like.

In some embodiments, the browser module of the auto-submission application 18 also obtains, at the same time, from the e-commerce merchant web server 12 the website markup language document which is needed for rendering of the e-commerce website's web page (operation 806). It will be appreciated that this data may under certain circumstances be obtained locally, when cached in order to speed up rendering of websites. In some embodiments, the browser module inserts the javascript modules into every web page markup language document, typically appending the modules at the end thereof, prior to proceeding with the rendering (displaying) of the particular web page (operation 808). The website's web pages accessed through the auto-submission application 18 is rendered and look the same as what they would normally look like in any browser, although a header bar, not forming part of the web page and indicating the use of the auto-submission application, may be overlayed on the web page, at the top of the browser. This header bar may, e.g., indicate the processing status of the particular website as “processed for auto-submission” (i.e. white-listed), “processing for auto-submission pending”, and blacklisted.

The end user is to shop by browsing through the various web pages of the e-commerce website, selecting one or more goods or services for purchase. On selection of goods or services, a shopping cart is updated. In an example embodiment where the secondary user device 22 is a small form factor card, e.g., a financial card device, the auto-submission application 18 monitors each web page of the merchant website and if, through fingerprinting, the web page is recognised by the javascript modules as a submission page (i.e. a page from which auto-submission may occur), the user may be prompted for an initiation action of the information submission process (screens 902, 904 and operation 810). For example, once the user has navigated to the e-commerce website's checkout page or any page from which checkout may occur, the auto-submission application 18 displays a prompt/message, e.g., as part of an overlay, prompt bar or other type of interface (see enlargement 906) requesting the user to send a submission initiation instruction. This is shown in screen 904 and the associated prompt bar enlargement 906 in FIG. 9. The prompt may request the user to perform a submission initiation action with the financial card device 22, if the user is ready for auto-submission (checkout) to commence. In this example embodiment, the user is prompted to tap the user's financial card device 22 on the tablet computer 14.

Once the user has performed this action (operation 812 in FIG. 8 and icon 908 in FIG. 9), and the auto-submission application 18 receives the submission initiation signal/instruction (operation 814), the auto-submission application 18 takes the necessary steps to commence (operation 816 and screen 910) and proceed with the auto-submission process. The first step may be to assess whether the initiation instruction has been received from a device activated/registered with the auto-submission application. This may be done by checking the device identifier against identifiers stored in the memory of the end user device. For example, if the message is a gesture instruction, the financial card device identifier may be considered against identifiers stored in the tablet computer memory. If the secondary user device is a mobile device, and the initiation instruction is received as a text message, the mobile number (MSISDN number) of the mobile device may be compares against identifiers stored in the tablet computer memory.

Steps may further include obtaining all relevant personal information from one or more devices/systems, which may include obtaining financial information from the bank server 20 (operation 818), thereby to enable the auto-filling of user data input fields that are to be presented to the user on one or more submission pages.

The communication between the auto-submission application 18 and the bank server 20 and/or other devices/systems may take place simultaneously, in parallel, or may follow a predetermined sequence.

As shown by operation 819, the auto-submission application 18 is to obtain the full purchase price relevant to the check-out process, which may be obtained from the merchant server or may, alternatively, be obtained from the tablet computer 14 itself, as the relevant amount may form part of the rendered and displayed web page. This purchase price total may, but need not, be made up of both the price of a product and a delivery charge.

The auto-submission application 18 also communicates with the bank server 20 (operation 818) to determine whether the user has sufficient funds available to purchase the item and complete the transaction (operation 822). This process is described in more detail below. In one example embodiment, the auto-submission application 18 may obtain from the bank server 20 a bank account balance or credit card balance, which is used by the application 18 to determine the sufficiency of funds. Alternatively, the application 18 may transmit the full purchase price to the bank server 20 which determines whether or not sufficient funds are available.

The bank server 20 may, in one example embodiment, provide the auto-submission application 18 with financial account information to enable the application to fill in at least some of the end user data input fields during the submission process (operation 818). For example, and in order to increase security, bank account or credit card details of the user may not be stored on the tablet computer 14, but may be obtained from the bank server 20 on request from the auto-submission application. In some embodiments, this information may be obtained by the transmission of a token to the bank server. Alternatively, or in addition, this information may be requested and provided through encrypted communications, in which the end user is identified through the financial card device identifier. In yet another variation, and as already mentioned, only portions/components of bank account or credit card details may be obtained from the bank server 20, with the remainder of portions being obtained from other devices, such as the end user device/tablet computer 14 and/or secondary user device/financial card device 22 (operation 824). The auto-submission application 18 is then configured to assemble the different components of the information before it is used to fill the user input data fields during the submission process.

In one example embodiment, the auto-submission application 18 is also configured to determine, after receipt of the submission initiation instruction from the financial card device 22 and before commencing the submission process, whether the application has all information/data necessary to fill in the user data input fields that form part of the submission process. The user data input fields forming part of the submission process are determined during the earlier processing of the website and stored by the application processing system 16. This information may be obtained by the auto-submission application 18 from the javascript/communication modules embedded in the web page (operation 826), or may be accessed through the discovery file.

The auto-submission application 18 obtains a list of the user data input fields of the submission process and then obtains the available user information from one or more devices/systems (operation 818, 824).

The auto-submission application 18 also holds relevant encryption information ready in order to decrypt information received back from the devices and/or systems.

The auto-submission application 18 has the intelligence and is configured to link the identified user data input fields with the user information/data stored in one or more locations. Once all available user information has been obtained, and as appropriate, decrypted and reassembled, the auto-submission application 18 is configured to determine whether any information is outstanding (operation 828) in terms of the identified user data input fields. The application 18 is configured to make a distinction between an auto-fill user data input field for which information is outstanding and a manual data field, such as a CAPTCHA data field, where manual user input is essential.

In one example embodiment, if it is determined that information is missing which will result in all user data input fields across web pages forming part of the submission process not being auto-filled, the auto-submission application 18 is configured to generate and present to the end user a missing data field screen (i.e. interface) which prompts the user to fill in the missing data (operation 830). On submission of the data by the end user, the auto-submission application 18 stores the information in a suitable format in the non-transient memory of the tablet computer 14. In one embodiment, the auto-submission application 18 may manage a process of splitting the additional data into components (portions) and arranging for the components to be stored across a number of devices/systems, for recombination and assembly prior to populating data fields if the information is needed in subsequent checkout processes with the same or other e-commerce merchants websites.

In an alternative embodiment, in circumstances where information necessary to fill all user data input fields identified by the javascript modules is not available, the auto-submission application 18 may be configured to request or prompt the user to manually fill in the missing data on the respective web pages (or application screens). For example, a user may be provided with an opportunity to fill in such information on the relevant information submission page after it is rendered, after some user data input fields have been auto-filled but before transitioning to a next (subsequent) web page occurs.

In one example embodiment, on initiating the submission process, the browser module renders an initiation submission (checkout) window (operation 832 and screen 912) which may contain (parts of) financial account information from the user (e.g., part of a credit card number associated with the financial card device 22, the remainder of the number being obfuscated for security reasons as shown by 914), the user's available funds in an account associated with the financial card device (or a combination of accounts) 916, an optional loyalty points balance 918, an indication of delivery/shipping address 920, and the total purchase price 922 associated with the transaction. The window includes a prompt in the form of an electronic submission (soft) button 924 or the like, for the user to provide a confirmation that the order should be placed.

If more than one delivery address is available for the end user, the delivery address indicated on the checkout window would typically be a delivery address indicated by the end user as a preferred delivery address and/or a default delivery address (such as the last delivery address used). However, the auto-submission application 18 is configured to allow the end user to select a different delivery address, e.g., from a drop down menu that appears on the selection of the indicated delivery address in the checkout window. In addition, the end user may be presented with an option to enter a new delivery address.

On receipt of the confirmation instruction, the browser module renders the first web page 926 forming part of the auto-submission process and inserts the necessary data, obtained in accordance with the identified user data input fields relating to with the submission process associated with the web page, into the user data input fields on the particular web page (operation 834). In one example embodiment, the auto-submission application 18 automatically progresses (transitions) the auto-submission process to the next web page 928 (operation 836) in response to which the browser module renders that page and fills in the necessary data into the respective user data input fields. Thus, in this embodiment, during the processing of the submission (checkout) pages of the e-commerce website, the application processing system would have identified submission inputs to move (progress) from one checkout web page to a further checkout web page. The javascript modules (or discovery file) may accordingly include instructions to auto-fill data fields and to navigate between consecutive checkout web pages 926, 928, 930 of the e-commerce merchant website.

The transmission of user data filled in during the submission process to the merchant server is typically in accordance with the normal functionality of the e-commerce checkout process, and will, e.g., occur on transition between web pages (operation 838).

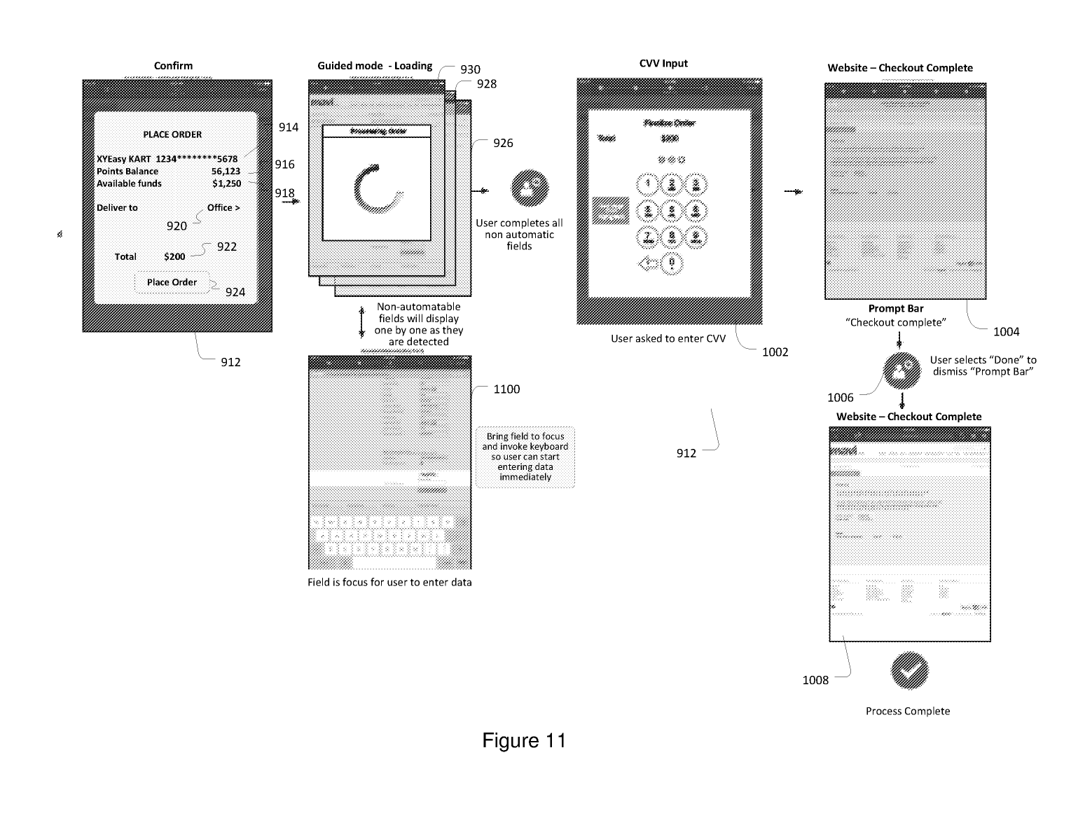

This process is continued until all the user input data fields have been filled, or until a manual data input field is present on a submission web page, in which case the automated checkout process is halted and the user prompted to manually fill in the particular field (operation 840). This is shown by screen 1100 of FIG. 11, which Figure shows the same process as in FIGS. 9 and 10, but includes the additional screen 1100. Once the user enters the information required by the manual field, the remainder of the checkout process is proceeded with. Typically, the web browser module of the auto-submission application 18 brings to the attention of the end user one after the other data input fields, through colouring or highlighting, which is to be manually filled in by the end user.

It will be appreciated that in some embodiments, although the browser module of the auto-submission application 18 automatically fills the various user data input fields, the user may still be required to manually click the submission button thereby to transition between checkout web pages and for data transmission to the merchant server 12 to occur. This arrangement may be used where there is a concern that the auto-filling of multiple checkout pages without an opportunity for the end user to review such checkout pages would be too disconcerting. This type of manual transitioning may also be used when the auto-submission application 18 is used for the first time on a submission process associated with a particular website, as it may increase a user's peace of mind. It may also be used on web pages of the submission process containing particular (e.g., sensitive) data input fields.

In an example embodiment of the invention, the auto-submission application 18 may be configured to request a final confirmation of the order from the user. An example of this is shown by screenshots in accordance with FIG. 10. For example, the auto-submission application 18 may present to the user a final window or interface, such as a popup screen, requesting either final confirmation of the transaction, e.g., through a transmission button or final confirmation gesture with the financial card device 22, or a final confirmation of the transaction together with the submission of the piece of information, e.g., in one example embodiment the CVV number of the relevant financial card (operation 842 of FIG. 8 and screen 1002 of FIG. 10). Once this confirmation has been received the auto-submission application's prompt bar changes to indicate that the checkout is complete (screen 1004), whereafter the end user can select the “Done” button on the prompt bar (icon 1006) before transitioning to the final page (screen 1008).

As already mentioned, the process of automatically filling data fields has been described in this example with respect to web pages from an e-commerce merchant web server. However, the processes described herein may be applied to any other type of web pages, mobile applications or other electronic documents which include user data input fields, such as a page of a mobile application, a word processor document, a spreadsheet, performing a banking transaction, filling out a form, etc.

It will be appreciated that unless an end user is required to manually fill in a data input field, there is no need to render and display each of the web pages or mobile application screens forming part of the auto-submission application 18. In one embodiment, the web browser of the auto-submission application 18 may be configured to automatically fill in the various web pages forming part of the checkout process without the pages being rendered or displayed to the user. This may increase the speed of the checkout process. In some embodiments, the pages may only be rendered in part.

In other embodiments, the web browser module of the auto-submission application 18 may be configured to display consecutive web pages, e.g., one on top the other, as greyed out web pages, thereby indicating that the web pages have been disabled for user input. As mentioned above, in a further embodiment, the web browser of the auto-submission application 18 may require user input to progress between consecutive checkout web pages, after the data input fields on the respective web page have been automatically filled.

It will be appreciated that one benefit of the present disclosure is that merchants need not adapt their checkout processes in order for auto-submission in accordance with the disclosure to be enabled. Rather, the backend processing of submission processes associated with websites allow the present auto-submission process to be adapted to these particular submission processes.

Communication/Interaction with Bank Server

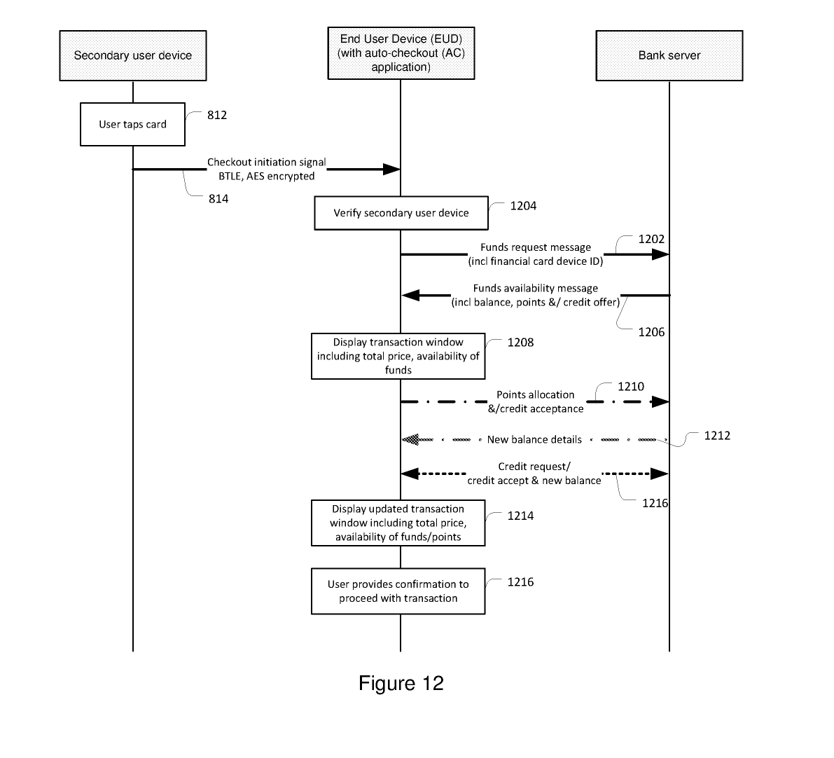

The communication between the auto-submission application 18 on the end user device 14 and the bank server 20 is described in more detail with reference to FIG. 12. As mentioned above, once the end user has performed the submission initiation action (operation 812), and on receipt of the submission initiation instruction (operation 814), the auto-submission application 18 commences with the auto-submission process and contacts the bank server 20.

For example, the auto-submission application 18 generates and transmits to the bank server 20 a funds request message which message includes a unique customer identifier (operation 1202). This customer identifier is typically the number provided by the bank server and stored on the tablet computer 14, as originally received from the bank server 20. Alternatively, the auto-submission application 18 may link a token to the unique customer identifier, which token is to be transmitted as part of the funds request message to the bank server 20.

As part of a further layer of security, the auto-submission application 18 may be configured to only transmit the funds request message to the bank server 20 if it is verified that the submission initiation instruction was received from a financial card device 22 associated with the end user device 14. For example, the submission initiation instruction may include the financial card device identifier, which is compared to the financial card device identifier stored in the end user device's non-transient memory 210 (operation 1204). Only if the financial card device identifier is authenticated will the funds request message be sent to the bank server 20.

The funds request message may be encrypted and may be sent via a secure channel to the bank server 20.

The bank server 20 receives the funds request message and performs a lookup against the financial account (or accounts) associated with the financial card device identifier of the user or the token. In one embodiment, the bank server 20 generates and transmits a funds availability message back to the end user device (operation 1206), which message contains information enabling the auto-submission application 18 to determine whether the user has sufficient funds to conclude the transaction. For example, the funds availability message may include information on the amount of funds available in the account of the user, such as the amount of funds (credit or otherwise) available, or merely an indication that sufficient funds for the transaction is available. Thus, the information on the amount of funds available may include the particular account limit.

Optionally, for example, in instances where the financial institution provides a reward or loyalty program or is partnered with a reward program, the bank server 20 or a separate loyalty server, may also provide the auto-submission application 18 with a reward/loyalty point total that may be applied against the transaction amount.

The funds availability message may further include transaction details, e.g., a credit or debit card number, etc, or portions (components) thereof, or other user personal information, e.g., user social security number (if applicable) or the like. This information may be to enable the auto-submission application 18 to enter the necessary financial information related to the end user, or any other requested user data, at a time of automatically filling in the submission web pages associated with the merchant website. In one embodiment of the invention, this information or parts thereof may, alternatively or in addition, be received from the financial card device 22 as part of the submission initiation instruction. Suitable encryption is to be applied to data transmitted.

The auto-submission application 18, on receipt of the funds availability message, generates and displays a transaction window to the user on the tablet computer 14, which transaction window shows the total price of the transaction, an availability of funds indication, e.g., an account balance and/or credit limit, optionally with the date of the balance, as well as, if available or relevant, the available loyalty points. Example embodiments of such a window is shown by screen 924 of FIGS. 9 and 11 and operation 1208 of FIG. 12. The end user is prompted to approve the transaction, which approval may include instructions to pay the purchase price from the funds available in the end user account at the financial institution. Alternatively, the approval may include instructions to pay the transaction amount in part, applying the loyalty points balance against the outstanding amount.

In one embodiment, the funds availability message transmitted to the bank server 20 may include the total purchase price, as determined or received by the auto-submission application 18 from the merchant. The bank server 20 is then to determine whether the end user has sufficient funds against this total purchase price by performing a lookup in terms of the financial account associated with the financial card device identifier. If sufficient funds are available, the process is to proceed as described above. However, if sufficient funds are not available to cover the purchase price, the bank server 20 may, e.g., in accordance with predefined rules, offer a credit advance, e.g., provide credit or increase a credit limit to the user (also shown by operation 1206). This offer to provide or increase credit is displayed to the end user on the transaction window on the tablet computer 14. The credit limit increase may be temporary or permanent.

An acceptance of the credit offer by the end user is entered by selecting an appropriate button, which acceptance is transmitted back to the bank server 20 (operation 1210). In response to the receipt of acceptance, the bank server 20 transmits a message to the end user device 14 (operation 1212) which enables the auto-submission application 18 to display an updated availability of funds to the user (operation 1214).

Alternatively, the bank server 20 may include an offer to provide credit or increase a limit associated with the account of the end user if it is determined that the funds available in the user account will fall below a predetermined minimum value after the e-commerce transaction has completed.

In other example embodiments, the original or a later transaction window displayed to the end user may be adapted to allow the user to request the provision of credit or a credit increase from the bank server 20 (operation 1216). This option may be provided even in circumstances where the user has sufficient funds to conclude the transaction. For example, the user may be presented a soft button to select thereby to generate a funds request.

A request for a credit increase, whether temporary or permanent, is transmitted to the bank server 20, and may be accepted or rejected based on predefined credit rules of the bank. Similar to the process described above, the bank server 20 is to transmit an acceptance message back to the auto-submission application 18, in which case an updated transaction window is generated and displayed to the end user.

Alternatively, the offer of credit may be presented to a user as a URL link to a credit request form which is to be completed and submitted to the bank server, e.g., through the transaction window interface, or an email. The credit request form may be part filled in accordance with the method set out above. Alternatively, the user may be provided with a telephone number to call.

As mentioned, all electronic communication with the bank server 20 will be secured by suitable encryption means and/or other security measures well-known to persons skilled in the art.

The auto-submission application 18 interacts with the bank server 20 through an application programming interface (API) on the bank's side. Communication with other systems, e.g., the application processing system 16 and merchant server 12 is also expected to occur through similar API's.

Data Structure

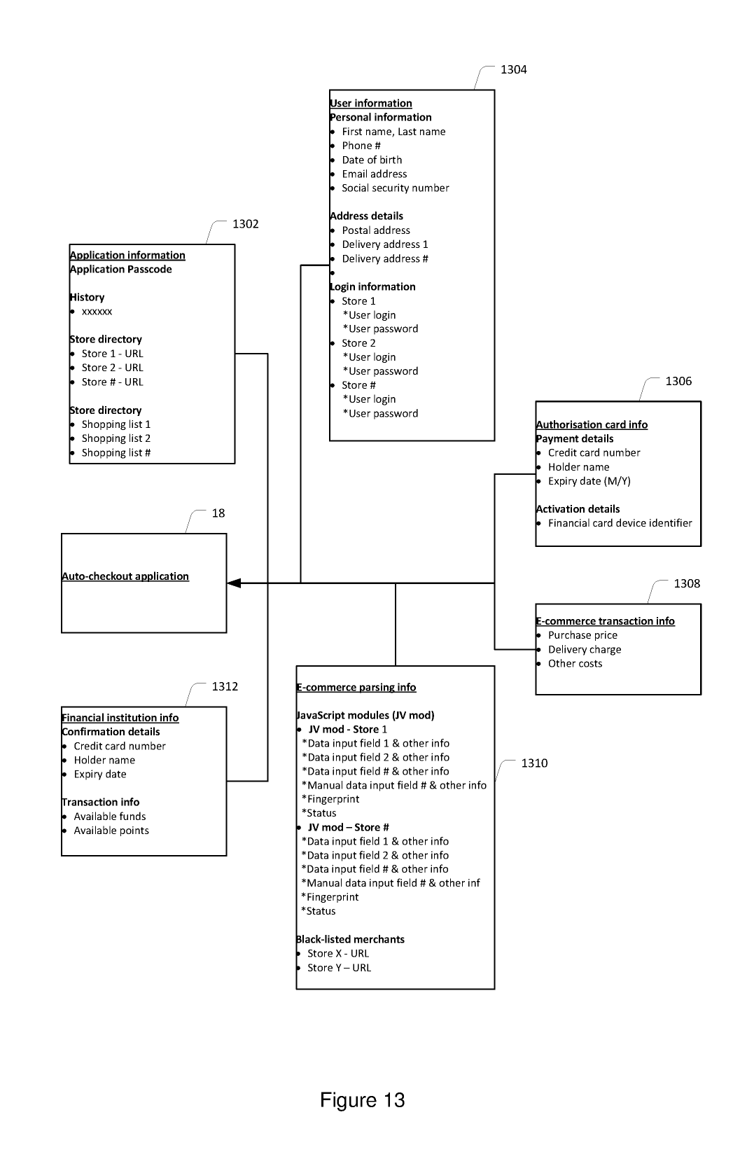

FIG. 13 shows an example embodiment of a data structure 1300 detailing data/information necessary for the operation of the embodiments described above.

The auto-submission application 18 stores in the non-transient memory 210 of the tablet computer 14 information necessary for the operation of the application 18 and interaction with an end user. For example, and as shown by reference numeral 1302, application information may include the application passcode which allows the end user access to the auto-submission application 18. The application information 1302 may also include information relating to e-commerce websites for which auto-submission is enabled, such as icons relating to each e-commerce store, related URL's and previous shopping lists associated with purchases made by the end user at respective e-commerce stores.

User information 1304, which, as described above, may be obtained from the end user during an initial activation/registration process, may include user personal information (e.g., any one or more of first and last names, contact numbers (various types of telephone numbers), date of birth, email address(es), social security number, if applicable), address details (including, e.g., postal address and one or more delivery addresses). User information may also include login details of the user to enable the user to conduct e-commerce transactions on websites of various merchants. Login details may include a login name and password. As has been mentioned above, this information may in one example embodiment be stored in the non-transient memory 210 of the tablet computer 14, or portions thereof may be stored on the tablet computer while portions may be stored on one or more other devices/systems, with there being a need for assembly prior to the use of the data.

Secondary user device information 1306 may also be stored, e.g., on the financial card device 22. In one embodiment, the information includes at least a financial card device identifier, stored in the non-transient memory of the device 22. Additionally, other financial account information may be stored on the device or in the bank server 20, e.g., including but not limited to the credit card number, holder name and expiry date. The financial account information may again be stored only on the financial card device 22, or alternatively, portions thereof may be stored on one or more devices/systems including the financial card device.

In terms of the e-commerce transaction information 1308 necessary to conclude the transaction, the purchase price total is to be available, as well as any delivery charges and other charges associated with a delivery address selected or defaulted on by the user.

The application processing system 16 stores information on e-commerce websites 1310, which information informs the operation of the auto-submission application. Associated with an identifier of an e-commerce website is a status, that indicates whether the e-commerce website is white-listed or black-listed as described above. Also, for each website communication modules (javascript modules) are stored which identify every data input field forming part of the web pages of the submission process and associated information (such as type of data field etc) which is, e.g., used to fill the data fields. Although not indicated, it will be appreciated that a discovery file or discovery files may be used in some embodiments, rather than the javascript modules.

The bank server 20 also stores financial institution information 1312 associated with the end user. For example, this information may include the credit card number, holder name, expiry date associated with a financial card device 22 as well as a financial card device identifier. Additionally, the bank server 20 has access to an account balance of the end user as well as loyalty or reward points associated with an account of the end user. As mentioned above, in instances where a financial card device is not used, the bank server may identify an end user through other types of client identifiers or tokens.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by real time network operating systems.

The disclosure of the embodiments is intended to be illustrative, but not limiting, of the full scope of the embodiments, which is set forth in the following claims.

It will be understood that the invention disclosed and defined in this specification extends to all alternative combinations of two or more of the individual features mentioned or evident from the text or drawings. All of these different combinations constitute various alternative aspects of the invention.

1. A computer-implemented method comprising:
displaying, on an end user device, a page associated with an e-commerce transaction;
receiving, at the end user device, an initiation instruction to commence a checkout process associated with the e-commerce transaction;
transmitting, to a bank server, a funds request message including at least a client identifier associated with the end user;
receiving from the bank server a funds availability message to determine whether an end user has sufficient funds to conclude the e-commerce transaction;
displaying, at the end user device, a total purchase price associated with the e-commerce transaction and an indication to show whether the user has sufficient funds available to conclude the e-commerce transaction; and
receiving an authorisation from the end user to proceed with the e-commerce transaction.

2. A computer-implemented method of claim 1 wherein the funds availability message includes an indication of the amount of available funds associated with an account of the end user.

3. A computer-implemented method of claim 2 wherein the funds availability message includes a total credit limit associated with the account of the end user.

4. A computer-implemented method of claim 2 wherein the funds availability message includes a statement date associated with the amount of available funds.

5. A computer-implemented method of claim 1 wherein the funds request message includes a total purchase price to conclude the e-commerce transaction.

6. A computer-implemented method of claim 5 wherein the funds availability message received from the bank server includes an offer to extend credit on an account of the end user, the method further comprising:
displaying, on the end user device, the offer to extend credit, together with the total purchase price to conclude the e-commerce transaction and the indication of the amount of available funds associated with the account of the user.

7. A computer-implemented method of claim 6 wherein the funds availability message includes the offer to extend credit on the account of the end user if it is determined that the user account does not have sufficient funds available to conclude the e-commerce transaction.

8. A computer-implemented method of claim 6 wherein the funds availability message includes the offer to extend credit on the account of the end user if it is determined that the funds available in the user account will fall below a predetermined minimum value after the conclusion of the e-commerce transaction.

9. A computer-implemented method of claim 7 wherein the method further comprises, in response to displaying the offer to extend credit, receiving from the end user device an input accepting the offer to extend credit, transmitting an acceptance message to the bank server and displaying an updated available funds amount at the user device which amount includes the extended credit.

10. A computer-implemented method of claim 6 wherein the offer to extend credit is presented to the end user as a soft button, a URL link to a credit request form, as an email or as a telephone number to call.

11. A computer-implemented method of claim 6 wherein the offer to extend credit is an offer to permanently or temporarily extend credit on the end user account.

12. A computer-implemented method of claim 1 wherein, on receipt of authorisation from the end user to proceed with the e-commerce transaction, information to conclude the e-commerce transaction is sent to a third party server associated with the e-commerce transaction.

13. A computer-implemented method of claim 1 wherein the page is a web page associated with an e-commerce website or is a screen or interface associated with an e-commerce mobile application.

14. A computer-implemented method of claim 1 further comprising determining that the initiation instruction to commence a checkout process has been received from a secondary user device registered with the end user device.

15. A computer-implemented method of claim 14 further comprising receiving the client identifier associated with the end user as part of the initiation instruction.

16. A system comprising:
a processor; and
a computer-readable storage medium having stored therein instructions which, when executed by the processor, cause the processor to perform operations comprising:
displaying, on an end user device, a page associated with an e-commerce transaction;
receiving, at the end user device, an initiation instruction to commence a checkout process associated with the e-commerce transaction;
transmitting, to a bank server, a funds request message including at least a client identifier associated with the end user;
receiving from the bank server a funds availability message to determine whether an end user has sufficient funds to conclude the e-commerce transaction;
displaying, at the end user device, a total purchase price associated with the e-commerce transaction and an indication to show whether the user has sufficient funds available to conclude the e-commerce transaction; and
receiving an authorisation from the end user to proceed with the e-commerce transaction.

17. A computer-implemented method comprising:
receiving, at a bank server and from an end user device executing an e-commerce transaction, a funds request message to determine whether an account associated with an end user has sufficient funds to conclude the e-commerce transaction, the funds request message including at least a client identifier associated with the end user;
by using the client identifier, performing a lookup of the account associated with the client identifier to determine an amount of funds available in the account; and
generating a funds availability message for transmission to the end user device, the funds availability message including information on the amount of funds available in the account of the user, which information is to be displayed on the end user device.

18. A computer-implemented method of claim 17 wherein the funds request message includes a total purchase price to conclude the e-commerce transaction on the end user device.

19. A computer-implemented method of claim 17 or claim 18, further comprising, if the bank server determines the account associated with the user identifier not to have sufficient funds to conclude the e-commerce transaction, including in the funds availability message information on an offer to extend credit on the account of the end user.

20. A computer-implemented method of claim 17 or claim 18, further comprising, if the bank server determines that the account associated with the user identifier will fall below a predetermined minimum value after the e-commerce transaction concludes, including in the funds availability message information on an offer to extend credit on the account of the end user.

21. A computer-implemented method of claim 19 or claim 20 further comprising receiving, from the end user device, an acceptance message accepting the offer to extend credit.
